(19) United States
(12) Patent Application Publication
(10) Pub. No.: US 2024/0018036 A1
(43) Pub. Date: Jan. 18, 2024

(54) GLASSY ELEMENT WITH MODIFIED INTERFACE AND METHOD FOR PRODUCING THE SAME

(71) Applicant: Schott AG, Mainz (DE)

(72) Inventors: Yakup Gönüllü, Essenheim (DE); Jovana Djordjevic-Reiss, Mainz (DE); Eveline Rudigier-Voigt, Mainz (DE); Inga Gheczy, Hofheim am Taunus (DE)

(73) Assignee: Schott AG, Mainz (DE)

(21) Appl. No.: 18/472,707

(22) Filed: Sep. 22, 2023

Related U.S. Application Data
(63) Continuation of application No. PCT/EP2022/057947, filed on Mar. 25, 2022.

(30) Foreign Application Priority Data
Mar. 25, 2021 (EP) 21164896.9
Mar. 25, 2022 (WO) PCT/EP2022/057947

(51) Int. Cl. C03C 23/00

(52) U.S. Cl. CPC C03C 23/006

(57) ABSTRACT

A method includes: providing a glassy element including a glass mesh structure and gap fillers at least at an interface area; heating the glassy element to a temperature whereas the gap fillers are mobilized in relation to the glass mesh structure; employing a radio-frequency plasma process that utilizes a plasma; and exposing the interface area to kinetic interaction members having a kinetic energy, whereby the kinetic interaction members interact with the gap fillers, whereby gap fillers are removed from the glass mesh structure, the kinetic interaction members are selected from the group consisting of noble gas ions, including any combinations thereof, the kinetic interaction members are the plasma or are resulting from the plasma and are directed to the interface area of the glassy element as effect of having a velocity with a vector pointing towards the respective interface area of the glassy element.

### CROSS REFERENCE TO RELATED APPLICATIONS

This is a continuation of International Patent Application No. PCT/EP2022/057947 filed on Mar. 25, 2022, which is incorporated in its entirety herein by reference. International Patent Application No. PCT/EP2022/057947 claims priority to European Patent Application No. 21164896.9 filed on Mar. 25, 21, which is incorporated in its entirety herein by reference.

### BACKGROUND OF THE INVENTION

### 1. Field of the Invention

The present invention is directed towards glassy elements and methods of producing glassy elements.

### 2. Description of the Related Art

Glassy elements are glass elements and/or glass ceramic elements. A glass element is known to have a vitreous glass structure which usually comprises a glass network structure which is mesh like and usually compounds or elements located in areas between the network structure as such. In the meaning of this description, those compounds or elements are called gap fillers. A glass ceramic element is, according to a standard scientific definition, a glass elements in which at least areas crystallizes, normally by heat treatment. In other words, the glass ceramic element comprises crystallized areas and a glass network structure, whereas the amount of crystallization can amount to 95% or higher, even 99% or higher.

Glassy elements with a modified interface, especially a gradient interface, can be used for multiple purposes. Normally, a glassy element has in principle a uniform structure of glass network and gap fillers, meaning that the composition including the network structure and the gap fillers within a volume elements is in principle the same for all volume elements, including that of its interface.

This composition can determine certain properties of the glassy element, whereas especially the composition at its interface can determine the properties of the interface, for example with regard to interface reactions. Therefore it is desirable to change or adapt the composition at the glassy element's interface in order to influence and/or adapt its interface properties. Thereby certain applications and further treatment procedures can be realized. The interface in the meaning of this description is the area of the end of the glassy elements, usually its interface. Of course the term interface can also comprise the area between different glassy elements, which can be composed from the same or even more advantageously different compositions.

For example, pharmaceutical containers, such as vials or syringes, are commonly used to store pharmaceutical compositions. Moreover, pharmaceutical compositions to be administered by injection usually comprise a pharmaceutical substance dissolved in water. If the pharmaceutical container is used to store the composition for a long time, especially the interaction between the pharmaceutical composition and the container influences the storage capability of the pharmaceutical composition. Glass as a material for pharmaceutical containers is advantageous, since, for example, it has a very low permeability with regard to gases. To enhance the resistance of the glass surface, it is well known to apply a coating, e.g. EP 0 821 079 A1 and EP 0 811 367 A1.

However, the stability of the coating, particularly at high pH-values can be problematic, especially under severe conditions or if the pharmaceutical container is used to store very sensitive pharmaceutical substances, such as biologics, in an alkaline buffer solution.

The adherence of the coating to the pharmaceutical container and/or other properties of the coating can benefit from the suitable preparation if the container's interface. Even more, the preparation and/or the local preparation of the interface can enable certain coatings which would otherwise not be possible with the unmodified interface.

However, it is known to modify the interface of a glass elements by plasma processes, such as plasma etching.

DE 10 2006 009 822 A1 and DE 10 2010 011 192 B4 disclose a plasma process in which chemically reactive process gases are used to chemically remove especially alkali ions from a glass surface.

US 2007/0232066 A1 discloses a method for the plasma treatment of glass surfaces, wherein the metal component, in particular the alkali and/or alkaline-earth metal component in the superficial region of the substrate are reduced by a plasma treatment of a substrate. US 2007/0232066 A1 discloses ammonia as a particularly suitable process gas, and that a plasma can be struck very well. The induced processes on the glass surface are of a chemical nature and effect true reactions on the glass surface.

U.S. Pat. No. 4,983,255 discloses a process for removing metal ions, particularly sodium, potassium and/or aluminum ions, from the thin outermost layer of items of glass or ceramic materials with enrichment by silicon dioxide. U.S. Pat. No. 4,983,255 employs corona discharge-induced plasma which requires high electric voltages of at least 6 kV. Such approaches are inherently hazardous and require strict operation and maintenance procedures to ensure safety.

### SUMMARY OF THE INVENTION

The inventors recognized the problem that during chemical reactive plasma etching processes the glass network structure is usually attacked by the process gases and therefore modified at its interface, which represent its interface area. This can lead to undesired properties of the glassy element's interface, for example another surface chemistry, especially with regard to bonding strength and reaction potential and the like. All in all this makes the prediction of the glassy element's interface behavior difficult. Therefore the invention provides a glassy element with a modified interface area, in which the glass network is in principle undamaged and the content and/or concentration of the gap fillers is modified when compared to the bulk area of the glassy element.

In some embodiments provided according to the invention, a method for providing a glassy element includes: providing a glassy element including a glass mesh structure and gap fillers at least at an interface area; heating the glassy element to a temperature T whereas the gap fillers are mobilized in relation to the glass mesh structure; employing a radio-frequency plasma process that utilizes a plasma; and exposing the interface area of the glassy element to kinetic interaction members having a kinetic energy. The kinetic interaction members interact with the gap fillers, whereby gap fillers are removed from the glass mesh structure. The kinetic interaction members are selected from the group consisting of noble gas ions, including any combinations thereof. The kinetic interaction members are the plasma or are resulting from the plasma and are directed to the interface area of the glassy element as effect of having a velocity with a vector pointing towards the respective interface area of the glassy element.

In some embodiments provided according to the invention, a glass element includes: a surface; a bulk, a glass network structure including Si; and one or more gap fillers selected from the group consisting of Na and K and characterized by one or more of the following properties: the gap filler is Na and a concentration of Na at the surface is depleted by a factor of at least 5.0 and a factor of 20.0 or less when compared to the bulk; or the gap filler is K and a concentration of K at the surface is enriched by a factor of at least 1.5 when compared to the bulk.

In some embodiments provided according to the invention, a glass element includes: a surface; a bulk, the surface extending towards the bulk; a glass network structure including Si; and one or more gap fillers selected from the group consisting of Na and K and one or more of the following conditions is fulfilled: Na is depleted at the surface and the Na depletion at the surface has a depth of 3 nm or more; or K is depleted in the surface and the K depletion into the surface has a depth of 2 nm or more.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a schematic view of a glass network structure with gap fillers;

FIG. 2 illustrates a schematic side view of a glassy element provided according to the invention;

FIG. 3 illustrates a schematic view of an apparatus for performing the method;

FIG. 4 illustrates a TOF-SIMS measurement of gap filler depletion in interface area;

FIG. 5A illustrates TOF-SIMS measurements for a soda-lime glass;

FIG. 5B illustrates sodium leaching in an interface area of the glass of FIG. 5A;

FIG. 6A illustrates TOF-SIMS measurements for a soda-lime glass;

FIG. 6B illustrates potassium leaching in an interface area of the glass of FIG. 6A;

FIG. 7A illustrates TOF-SIMS measurements for a borosilicate glass;

FIG. 7B illustrates sodium leaching in an interface area of the glass of FIG. 7A;

FIG. 8A illustrates TOF-SIMS measurements for a borosilicate glass; and

FIG. 8B illustrates potassium leaching in an interface area of the glass of FIG. 8A.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

A glass, in the meaning if the invention a glass from inorganic components, can in principle be regarded as a glass network structure which has some room, in which gap fillers are located. For example the glass network is formed from network forming components such as SiO₂ and Al₂O₃ building the glass network, whereas Li and/or Na and/or Ca (or Li₂O and/or Na₂O and/or CaO) are gap fillers located in the gaps.

In some embodiments, the terminology of ‘glassy element’ and ‘glass element’ within this disclosure may be understood as synonymous.

Method for Providing a Glassy Element

Given the goal of the invention, the invention provides a method for providing a glassy element, which method comprises the steps of providing a glassy element comprising a glass network structure and gap fillers at least at an area, heating the glassy element to a temperature T, which is optionally below Tg, whereas the gap fillers are mobilized in relation to the glass network structure, and exposing at least an interface area of the glassy element to kinetic interaction members having a kinetic energy, whereby the kinetic interaction members interact with the gap fillers, whereby gap fillers are removed from glass network structure.

The interface area is in this case the surface area. In the meaning of this description, interface and surface are often used synonymously, because in the description relating to the method the interface is the surface, in the description relating to the glassy element there can be further items such as coatings on the surface, therefore in this case the surface represents the interface. Or in other words, the former surface can be the later interface. Of course, the term “surface” can also be seen as interface to the surrounding space or atmosphere.

As can be seen, a basic concept of the invention is to mobilize the gap fillers which thereby can so to say move or travel in relation to the glass network structure. Another important aspect is that the gap fillers are so to say loosened compared to the glass network structure as well. This mobilization is achieved advantageously by heating the glassy element. Optionally, the maximum temperature to which the glassy element is heated is Tg, which is as commonly known the glass transformation temperature, also referred to as the glass-transition temperature. If the glassy element consists of an amorphous glass, this Tg refers to the transformation temperature of the glass. If the glassy element is a glass ceramic element, Tg refers to the transformation temperature of the glass phase between the crystallized areas.

The surface area of the glassy element, which represents an interface to the surrounding atmosphere or vacuum, is according to the invention exposed to kinetic interaction members. Those are items having a mass and velocity, which so to say collide with the glassy element's interface and remove the mobilized gap fillers from the interface. It is assumed that the predominant effect for this removal is that the kinetic interaction members, when colliding with the glass network and the mobilized gap fillers, transfer an impulse to both, whereas the gap fillers, due to their mobilization, are removed from the interface. Thereby the interface is modified by a predominantly physical effect with predominantly no chemical interaction, leading to an unchanged and/or intact glass network within the interface area. In other words, the gap fillers are so to said selectively leached out of the glass.

By the described method, the glass network structure at the interface of the glassy element being exposed to the kinetic interaction members remains unchanged when compared to the glass network structure within the volume of the glass element.

Advantageously, the glass network structure comprises Si bonds, which are preserved during the exposition with the kinetic interaction members. Such are most often favorable for the chemical behavior and properties of the glass, which by the application of the procedure remains predictable.

In some embodiments of the method provided according to the invention, during exposition of the glassy element with the kinetic interaction members no chemical reactive species are exposed to the glassy element. The kinetic interaction members are chemically inactive against the glass network structure and advantageously they are not mixed to a gas and/or other species which are under the applied conditions chemically reactive at least towards the glassy element's interface.

Optionally the kinetic interaction members are selected from the group of noble gases or noble gas ions, optionally Ar, Ar ions, He, He ions, Ne, Ne ions, Kr, Kr ions and/or Xe and/or Xe ions, including any combinations thereof.

The gap fillers which can be advantageously removed from the glass network structure by the inventive method are alkaline metals and/or earth alkaline metals, optionally Li and/or Na and/or K and/or Cs and/or Mg and/or Ca and/or Sr and/or Ba including the respective oxides thereof.

It has to be said that not necessarily all gap fillers in the interface area need to be removed. By the described procedure and removal of gap fillers, the concentration of gap fillers at least in the interface area is at least reduced.

By the heating of the glassy elements, the gap fillers are mobilized and are so to say allowed to travel within the glassy element's volume. Optionally the gap fillers are alkaline metals and/or earth alkaline metals, optionally Li and/or Na and/or K and/or Cs and/or Mg and/or Ca and/or Sr and/or Ba including the respective oxides thereof. Correspondingly, the glasses and/or glass compositions to be treated by the described procedure can be chosen and/or optimized for this respect. The same of course holds true for the corresponding oxides.

In some embodiments, gap fillers are at least partially removed from the interface area of the glassy element.

According to some embodiments, the removal of the gap fillers results in a gradient area within the glassy element in which the concentration of the gap fillers is reduced when compared to an area outside the gradient area. Outside the gradient area usually means the bulk of the glassy element. The gradient area usually extends from the interface, most common the surface of the glassy element, into its depth. The gradient area usually has a thickness of about 1 nm to 200 nm, measured as the distance from the interface. Maximum depths can also be 150 nm and/or 100 nm and/or 75 nm. Those values can of course all be combined with said minimum depths.

In some embodiments, which may be best suitable when there are low gradients of gap filler concentration in the gradient area, the difference of the maximum concentration of gap fillers in the bulk and the minimum concentration of gap fillers at the interface is taken into account.

According to this measurement, D is the thickness or synonymously depth of the gradient area, CB is the concentration of gap fillers in the bulk (or in other words, within the volume, away from the interface zone with the modified gap filler content) of the glassy element, and CI is the concentration of the gap fillers at the interface, most often the surface, and DeltaC is the difference between CB and CI.

Applying this scheme, the depth D is where the concentration of gap fillers is 90% of DeltaC. It goes without saying that D is mostly measured perpendicular to the plain of the interface.

The concentration of gap fillers can be measured by TOF-SIMS. This is a known analytical method and not further described here. Advantageously, in contrast to XPS assays (X-ray photoelectron spectroscopy), ToF-SIMS imaging is a very sensitive technique which allows surface analysis with sampling depths in nanometer range, e.g. the 1-2 nm range is accessible. ToF-SIMS also enables high spatial resolution imaging.

The area in which the gap fillers are depleted and/or their concentration is reduced when compared to the original concentration prior to the application of the procedure has a certain depth, typically of some to some hundred nanometers. It is assumed that this is achieved by a diffusion effect of mobilized gap fillers. When gap fillers are removed from the interface, in this case the surface of the glassy element, gap fillers travel from the bulk of the glassy element into the depleted zone and are then removed when reaching the interface. Therefore, the concentration of gap fillers in the interface area and any gradients of the concentration profile into the depth of the glassy element might be an effect of parameters involving temperature, mobilization rate, depletion rate, network interaction, time of depletion and more. A person skilled in the art will be able to apply the described inventive process in order to create interface areas as he desires.

As described, the procedure results in a modified interface of a glassy element, wherein the glass network remains chemically unchanged. This result might be proven by various ways. One is that the described process takes place under a controlled atmosphere where the kinetic interaction members represent a gas or plasma with a pressure below normal atmospheric pressure. The composition of this atmosphere is known and can be analyzed. During and/or after the application of the process, the chemical composition of this atmosphere can be analyzed. The inventors found out that no excess traces of glass network components in the aforesaid example Si and/or Al or chemical compounds containing those and no depletion of the enclosed atmosphere could be found. This leads to the proof that, by application of the described process, there is no chemical reaction of the glass network takes place. Therefore, the glass must be considered to remain chemically unchanged.

As described before, the kinetic interaction members interact with the interface of the glassy element by a mechanism of collision. Therefore, the kinetic interaction members are advantageously directed to the interface of the glassy element as effect of having a velocity with a vector pointing towards the respective interface area of the glassy element. Because the kinetic interaction members have a mass they also have a kinetic energy. The kinetic interaction member can be provided with their kinetic energy by being a plasma and/or an effect of a plasma discharge and/or can be directed to the respective interface area of the glassy element by an ion gun. In some embodiments, the method foresees that the kinetic interaction members are a plasma of noble gases, especially the said noble gases.

In some embodiments, a lower than atmospheric pressure is applied at least during the exposition of the glassy element with the kinetic interaction members. This way the path lengths of the kinetic interaction members is kept long and/or the kinetic interaction members do not lose an undesirable amount of their velocity by collision with other elements being present in the process entity, which most often is a vacuum chamber. This technology is common in plasma processes.

In order to mobilize the gap fillers as described, optionally a heating of the glassy element is performed. This may be a pre-heating, which is it least started prior to the exposition with kinetic interaction members. The heating of the glassy element may be advantageously achieved by exposing the glassy element to a heating device. Such heating device can be in direct contact with the glassy element and/or irradiates the glassy element with electromagnetic radiation, optionally IR radiation.

An alternative or an additional heating procedure of the glassy element is represented by at least partially exposing the glassy element to heating gas. Optionally the heating gas is a plasma. It was observed that advantageously the heating gas and/or the plasma comprises and/or consists of O₂ and/or oxygen ions. N₂ or the results of a N₂ plasma, namely nitrogen ions, can be applied as well.

The inventors found out that the heating, especially the pre-heating of the glassy element by the described exposition of the glassy element with the heating gas and/or heating gas plasma results in a pretreatment of the glassy element's interface.

In case O₂ and/or a O₂ plasma are used, the chemical interaction with the glass interface can condition the least for the removal of the gap fillers by the kinetic interaction members. For example, OH bonds being present on a glass surface can be removed that way, whereas SiO₂ remains. It can be assumed that OH bonds in the interface might block the surface from gap fillers travelling to the surface and therefore might clock the removal process with kinetic interaction members, and/or that the OH bond structure might be detrimental for the kinetic interaction members to hit gap fillers being located near the surface. Similar aspects might apply when N₂ or a N₂ plasma is used a heating gas, whereas SiN bonds might result. Those could also provide other beneficial surface effects. This way, a synergistic effect can be observed when pre-heating the glassy element with a heating gas prior to its exposition with kinetic interaction members. Such effects might also play a role when the kinetic interaction members are chosen, for example when Ar is used as kinetic interaction member, then a pre-heating with O₂ as heating gas, especially an O₂ plasma, may be most advantageous.

As described before, the heating of the glassy element with the heating gas might and/or should result in a chemical interaction with the glassy element's interface. The exposition with the kinetic interaction members should not result in a chemical reaction, as described above. Therefore it may be advantageous if the process of heating the glassy element and exposing it to the kinetic interaction members is separated. Thereby, during the exposition of the glassy element with the kinetic interaction members no heating gas is present in the surrounding atmosphere.

Optionally, as indicated above, providing the kinetic interaction members with energy is achieved by the ignition of a plasma of a gas comprising or consisting of the kinetic interaction members. The exposition of the glassy element with kinetic interaction members may thereby advantageously be a plasma process as well, such as a pulsed plasma process.

For a plasma process usually a process gas is used. The kinetic interaction members may advantageously be present in form of a process gas, which does not contain a chemically reactive species for the glassy element's interface. Of course there can be a mixture of kinetic interaction members or their precursors in the process gas, or at least the process gas is free of species which are chemically reactive at least for the interface of the glassy element.

In some embodiments, providing the heating gas with energy is achieved by the ignition of a plasma of a gas comprising or consisting of the heating gas. The exposition of the glassy element with the heating gas thereby may advantageously be a plasma process as well, such as a pulsed plasma process.

This means that the same technology can be advantageously applied for pre-heating and for the exposition with kinetic interaction members, which provides advantages for the complexity and the efforts which needs to be invested in the machinery. For example, the same treatment chamber, vacuum pumps and plasma generators can be used for pre-heating of the glassy element and the removal of the gap fillers, only the gases might be exchanged in the treatment chamber, especially without the need to remove the glassy element.

In the light of the foregoing it is considered to be beneficial to perform the heating in a way which is conserving the glass network structure, meaning that the heating should not result in a chemical decomposition and/or should not induce chemical reactions of the glass network structure.

Of course it is also possible that the impact of the kinetic interaction members leads or contributes to the heating of the glassy element.

In some embodiments, the electromagnetic radiation is applied in a pulsed manner. For example, in sequences of pulse time and pause time. In some embodiments, the pause time is greater than the pulse time. Especially, steep gradients, especially within the surface-near region of the glassy element, in the raise and/or decrease of the pulse energy can be applied.

As indicated by the foregoing description, the glass network structure provided according to the invention is conserved and remains at least predominantly unchanged by the procedure. The application of the pulsed electromagnetic radiation so to say does not overstress the bonds of the glass network. This pulse sequence might be present in a modulation, wherein the intensity of the radiation is varied, but also in a manner where the radiation is switched off for a certain period of time, leading to a sequence of pulse and pauses. An exemplary procedure applies a pulse sequence where the pause time is greater than the pulse time. Of course, combinations of the aforesaid pulse application are possible and provided according to the invention.

In some embodiments of the inventive method, the heating of the glassy element and/or the exposition with the kinetic energy members is performed at the process temperature PT1, which is 80° C. to Tg of the glass of the glassy element, optionally 80° C. to 500° C., optionally 120° C. to 450° C., optionally 150° C. to 320° C., optionally 160° C. to 300° C., optionally 160° C. to 195° C.

In some embodiments, the exposition with the kinetic interaction members takes several seconds to some minutes. Depending on the depth of the gradient area and maximum depletion to be achieved, 2 s to 30 s are viable parameters. In more demanding cases, 2 min to 45 min are adequate, whereas 10 min to 30 min might be a beneficial range as well. This exposition with kinetic interaction members takes advantageously place at the aforesaid temperature ranges.

In some embodiments of a method for producing the glassy element, the heating of the glassy element and/or the providing of the kinetic interaction members with kinetic energy is achieved by irradiation by a microwave generator, optionally wherein the microwave has a frequency of 300 MHz to 300 GHz, optionally 600 MHz to 100 GHz, optionally 800 MHz to 10 GHz, optionally 900 MHz to 3 GHz, optionally 2.45 GHz.

However, radiowaves are also possible. Radiowaves typically are attributed to a range of 3 kHz to 300 MHz.

A pulsed creation of kinetic interaction members may be advantageous, as described in detail before. A corresponding method comprised the principle that the kinetic interaction members achieve their kinetic energy as effect of a pulsed plasma with the pulse duration PD1. Optionally, the pulse duration PD1 of the plasma is 20 μs or less, optionally 15 μs or less, optionally 12 μs or less, optionally 8 μs or less, optionally 6 μs or less, optionally 4 μs or less, optionally 3 μs; and/or wherein the pulse duration PD1 of the plasma is 0.1 μs or more, optionally 0.5 μs or more, optionally 1 μs or more.

In some embodiments of the method, the input power IP1 of the radiation generator, optionally the input power IP1 of the microwave generator for the microwave irradiation, is 1000 W to 10000 W, optionally 2100 W to 8000 W, optionally 2500 W to 6700 W, optionally 3000 W to 6000 W, optionally 3200 W to 5500 W, optionally 4000 W to 5000 W.

By the combination of the radiation frequency, the pulse duration and/or the irradiation energy a beneficial removal of the gap fillers from the glassy element can be achieved in an advantageous way.

An exemplary method follows the principle that the heating of the glassy element as well as providing the kinetic interactions members with kinetic energy is achieved by a plasma process, comprising the steps:
a) surrounding the at least part of the interface of the glassy element with a precursor P1 of at least the kinetic interaction member or the kinetic interaction members; and
b) irradiating the precursor P1 to generate a plasma;
wherein at least one, optionally all, of the following parameters is/are fulfilled:
i) wherein the temperature of the glassy element is above room temperature to Tg or 80° C. to Tg of the glass of the glassy element, optionally 80° C. to 500° C., optionally 120° C. to 450° C., optionally 150° C. to 320° C., optionally 160° C. to 300° C., optionally 160° C. to 195° C.; and/or
ii) wherein the pulse duration PD1 of the plasma is 20 ms or less, optionally 15 ms or less, optionally 8 ms or less, optionally 6 ms or less, optionally 2 ms or less, optionally 1 ms or less, optionally 0.5 ms; and/or
iii) wherein the pulse duration PD1 of the plasma is 0.1 ms or more, optionally 0.2 ms or more, optionally 0.3 ms or more, optionally 0.5 ms or more; and/or
iv) wherein the irradiation is carried out by a microwave generator, optionally wherein the ray has a frequency of 300 MHz to 300 GHz, optionally 600 MHz to 100 GHz, optionally 800 MHz to 10 GHz, optionally 900 MHz to 3 GHz, optionally 2.45 GHz; and/or
v) wherein the input power IP1, optionally the input power IP1 of the microwave generator, is 1000 W to 10000 W, optionally 2500 W to 8000 W, optionally 4000 W to 8000 W, optionally 5000 W to 7000 W, optionally 5000 W to 6500 W, optionally 5250 W to 5750 W; and/or
vi) the precursor P1 comprises noble gas and/or nitrogen, optionally; and/or
vii) wherein the precursor P1 comprises, optionally consist of, the elements He, Ne, Ar, Kr and/or Xe;
viii) the pulse pause PP1 between two pulses is 1 μs or more, optionally 10 μs or more, optionally 1 μs to 5 s, optionally 0.1 ms to 10 ms, optionally 0.5 ms to 2.0 ms, optionally 1.5 ms to 2.0 ms, optionally 1.8 ms; and/or
ix) the total time TT1 of irradiation is 0.1 s or more, optionally 1 s or more, optionally 1 s to 5 min, optionally 5 s to 15 s; and/or
x) the ratio [ms/ms] of all pulse durations PD1 [ms] to all pulse pauses PP1 [ms] is 0.05 or more, optionally 0.1 or more, optionally 0.15 to 5, optionally 0.2 to 0.5; and/or
xi) wherein the process pressure PR1 is 0.01 mbar to 500 mbar, optionally 0.1 mbar to 100 mbar, optionally 0.5 mbar to 10 mbar, optionally 0.8 mbar to 6.0 mbar, optionally 1.0 mbar to 4.0 mbar; and/or
xii) wherein the process temperature PT1 is increasing, optionally steadily increasing, during the plasma pretreatment; and/or
xiii) wherein the process temperature PT1 is at least partially, optionally at the time when the plasma pretreatment process ends, 80° C. or more, optionally 100° C. or more, optionally 180° C. or more, optionally less than 200° C.; and/or
xiv) wherein the flow rate of the precursor P1 is 0.1 to 500 sccm, optionally 5 to 400 sccm, optionally 50 to 400 sccm, optionally 100 to 300 sccm.

It goes without saying that the above mentioned steps can be combined in any suitable manner, also leaving out certain steps. Optionally the heating of the glassy element is started prior to the exposition with kinetic interaction members.

The invention is not limited to the method for producing and/or preparing the glassy element. Moreover, the invention provides a glassy element, which is achievable by the described method or methods as well.

Glassy Element

Especially, the invention provides a glassy element, wherein the glassy element has at a least a volume area and at least one interface area, wherein the glassy elements comprises a glass network structure and gap fillers within the volume area, whereby the concentration of gap fillers within the at least one volume area is CV. The volume area, is said before, the bulk of the glassy element. The glassy element also comprises a glass network structure at the interface area, which is the same or at least predominantly the same as in the volume area. “Predominantly the same” means that the glass network forming components and the glass network structure is derived from the original glass network structure in the volume area, whereas deformation due to surface effects or reforming due the removal or at least dilution of the gap fillers is possible. In the interface region, which usually is the surface region of the glassy element, the concentration CI of the gap fillers in the interface area is lower than the concentration CV of gap fillers within the volume area.

As described earlier, in the interface region the gap fillers are leached out from glass network structure, resulting in the relation CV>CI.

Optionally, in the glassy element the glass network structure is the same in the volume area as in the interface area. Optionally, the glass network structure comprises Si bonds coordinated to other components in a Si bond structure, wherein the Si bond structure in the volume area is the same as in the interface area or at least predominantly the same.

In an exemplary glassy element the gap fillers are alkaline metals and/or earth alkaline metals, optionally Li and/or Na and/or K and/or Cs and/or Mg and/or Ca and/or Sr and/or Ba. This statement also comprises their referring oxides.

As said before, in the interface area of the glassy element there may be a gradient in which the concentration of the gap fillers is reduced when compared to an area outside the gradient area; usually the gradient area extends from the interface of the glassy element into its depth. Usually the gradient area has a thickness of about 150 nm.

More accurately the thickness of the gradient is measured by applying the DeltaC consideration as described above.

Some words might be spent on the term gradient area itself. It is possible that glassy elements provided according to the invention have very steep gradients of the depletion of gap fillers when going from the bulk or volume area to the interface, even being similar to delta-functions, or having very smooth gradients by which the depletion of the gap fillers is low when going from increment to increment. It can be speculated that this is an effect of the strength of the glass network holding the gap fillers within the gap, but also an effect of the rate of removal from the interface of the glassy element, and most probably combinations of all. One benefit of the invention is that the gradient profiled can be adjusted or chosen according to the needs.

Coating

Such need can be the further processing of the described glassy element. In some embodiments, the glassy element is used as substrate for a further processing, such as a coating. This especially can be a functional coating. The described glassy element with the described modified interface can enable and/or at least improve the behavior of the coatings to be applied. The coating composition and coating structure can advantageously interact with the interface of the glassy element, which is tuned and/or adjusted as described. By this synergistic effect, new or at least improved coating properties can be achieved.

Therefore, the invention also provides a glassy element with a described modified interface, wherein a coating and/or coating system is applied on top of the interface area. Optionally, the coating interacts with the interface area on due to chemical and/or physical interaction.

Coating system in the meaning of the foregoing sentence means more than one layer of coating or a coating with multiple components within one layer.

In some embodiments, the coating or coating system applied to the interface area of the glassy element has a higher adherence to the glassy element compared to the same coating or coating system applicable to an area outside the interface area. This means in other words that by providing a glassy element provided according to the invention as substrate for a coating, the adherence of the coating to the glassy element can be advantageously improved.

The coating can be applied by various coating processes. Examples are a physical vapor deposition process (PVD) or a chemical vapor deposition process (CVD). Optionally, the coating process is a plasma-enhanced chemical vapor deposition (PECVD) process, plasma impulse chemical vapor deposition (PICVD) process or plasma assisted chemical vapor deposition (PACVD) process. Especially, if the process is a plasma impulse chemical vapor deposition (PICVD) process, both the process temperature and the pulse duration of the microwave plasma can be controlled in an advantageous manner. The resistance and stability of the layer can be further improved if the process is a plasma impulse chemical vapor deposition process and the process temperature and the pulse duration of the microwave plasma are within the ranges described herein.

Glass Composition

The glassy element can, for example, consist of or at least comprise a glass composition of a borosilicate glass, an aluminosilicate glass, or a lithium-aluminosilicate (LAS) glass.

Many glass systems and/or glass compositions can be advantageously used in the glassy element. This also comprises glass ceramics as described before.

An exemplary composition of the glassy element comprises, in mass-%:
SiO₂: 30 to 98%, optionally 50 to 90%, optionally 70.0 to 74.0%; and/or
B₂O₃: 0 to 30%, optionally 3 to 20%, optionally 7.0 to 16.0%; and/or
Al₂O₃: 0 to 30%, optionally 1 to 15%, optionally 3.0 to 6.5%; and/or
X₂O: 0 to 30%, optionally 1 to 15%, optionally 2.0 to 7.2%, wherein X is selected from Na, K, Li, optionally X is Na and/or K; and/or
YO: 0 to 30%, optionally 0.1 to 5%, optionally 0.5 to 1.0%, wherein Y is selected from Ca, Mg, Ba, optionally Y is Ca and/or Mg.

Therein X₂O and/or YO usually represent or at least comprise the gap fillers. The other components usually form the glass network. This also holds true for the following compositions.

Another exemplary composition of the glassy element consists of, in mass-%:
SiO₂: 30 to 98%, optionally 50 to 90%, optionally 70.0 to 74.0%;
B₂O₃: 0 to 30%, optionally 3 to 20%, optionally 7.0 to 16.0%;
Al₂O₃: 0 to 30%, optionally 1 to 15%, optionally 3.0 to 6.5%;
X₂O: 0 to 30%, optionally 1 to 15%, optionally 2.0 to 7.2%, wherein X is selected from Na, K, Li, optionally X is Na and/or K;
YO: 0 to 30%, optionally 0.1 to 5%, optionally 0.5 to 1.0%, wherein Y is selected from Ca, Mg, Ba, optionally Y is Ca and/or Mg; and optionally unavoidable impurities.

Another exemplary composition of the glassy element comprises, in mass-%:
SiO₂: 20 to 98%, optionally 40 to 75%, optionally 50 to 65%; and/or
B₂O₃: 0 to 30%, optionally 1 to 15%, optionally 3 to 9%; and/or
Al₂O₃: 0 to 30%, optionally 10 to 20%, optionally 13 to 18; and/or
X₂O: 0 to 30%, optionally 0 to 5%, optionally 0 to 3%, wherein X is selected from Na, K, Li, optionally X is Na and/or K; and/or
YO: 0 to 50%, optionally 0.1 to 40%, optionally 10 to 35, wherein Y is selected from Ca, Mg, Ba, optionally Y is Ca and/or Mg.

Another exemplary composition of the glassy element consist of, in mass-%:
SiO₂: 20 to 98%, optionally 40 to 75%, optionally 50 to 65%;
B₂O₃: 0 to 30%, optionally 1 to 15%, optionally 3 to 9%;
Al₂O₃: 0 to 30%, optionally 10 to 20%, optionally 13 to 18;
X₂O: 0 to 30%, optionally 0 to 5%, optionally 0 to 3%, wherein X is selected from Na, K, Li, optionally X is Na and/or K;
YO: 0 to 50%, optionally 0.1 to 40%, optionally 10 to 35, wherein Y is selected from Ca, Mg, Ba, optionally Y is Ca and/or Mg; and optionally unavoidable impurities.

In some embodiments, the composition of the glassy element comprises, by weight,
SiO₂: 30 to 98%;
B₂O₃: 0 to 30%;
Al₂O₃: 0 to 30%;
X₂O: 0 to 30%, wherein X is selected from Na, K, Li, optionally X is Na and/or K; and
YO: 0 to 30%, wherein Y is selected from Ca, Mg, Ba, optionally Y is Ca and/or Mg.

In some embodiments, the composition of the glassy element comprises, by weight,
SiO₂: 50 to 90%;
B₂O₃: 3 to 20%;
Al₂O₃: 1 to 15%;
X₂O: 1 to 15%, wherein X is selected from Na, K, Li, optionally X is Na and/or K; and
YO: 0.1 to 5%, wherein Y is selected from Ca, Mg, Ba, optionally Y is Ca and/or Mg.

In some embodiments, the composition of the glassy element comprises, by weight,
SiO₂: 70.0 to 74.0%;
B₂O₃: 7.0 to 16.0%;
Al₂O₃: 3.0 to 6.5%;
X₂O: 2.0 to 7.2%, wherein X is selected from Na, K, Li, optionally X is Na and/or K; and
YO: 0.5 to 1.0%, wherein Y is selected from Ca, Mg, Ba, optionally Y is Ca and/or Mg.

In some embodiments, the composition of the glassy element comprises, by weight, 30 to 98% SiO₂, 50 to 90% SiO₂, 60 to 80% SiO₂, or 70.0 to 74.0% SiO₂. In some embodiments, the composition comprises, by weight, at least 30% SiO₂, at least 50% SiO₂, at least 60% SiO₂, or at least 70.0% SiO₂. In some embodiments, the composition comprises, by weight, 98% SiO₂ or less, 90% SiO₂ or less, 80% SiO₂ or less, 74.0% SiO₂ or less.

In some embodiments, the composition of the glassy element comprises, by weight, 0 to 30% B₂O₃, 3 to 20% B₂O₃, or 7.0 to 16.0% B₂O₃. In some embodiments, the composition comprises, by weight, 0% B₂O₃ or more, 3% B₂O₃ or more, or 7.0 B₂O₃ or more. In some embodiments, the composition of the glassy element comprises, by weight, 30% B₂O₃ or less, 20% B₂O₃ or less, or 16.0% B₂O₃ or less.

In some embodiments, the composition of the glassy element comprises, by weight, 0 to 30% Al₂O₃, 1 to 15% Al₂O₃, or 3.0 to 6.5% Al₂O₃. In some embodiments, the composition comprises, by weight, 0% Al₂O₃ or more, 1% Al₂O₃ or more, or 3.0% Al₂O₃ or more. In some embodiments, the composition comprises, by weight, 30% Al₂O₃ or less, 15% Al₂O₃ or less, or 6.5% Al₂O₃ or less.

In some embodiments, the composition of the glassy element comprises, by weight, 0 to 30% X₂O, 1 to 15% X₂O, or 2.0 to 7.2% X₂O, wherein X is selected from Na, K, Li, optionally X is Na and/or K.

In some embodiments, the composition of the glassy element comprises, by weight, 0 to 30% Na₂O, 1 to 15% Na₂O, or 2.0 to 7.2% Na₂O. In some embodiments, the composition comprises, by weight, 0% Na₂O or more, 1% Na₂O or more, or 2.0% Na₂O or more. In some embodiments, the composition comprises, by weight, 30% Na₂O or less, 15% Na₂O or less, or 7.2% Na₂O or less.

In some embodiments, the composition of the glassy element comprises, by weight, 0 to 30% K₂O, 1 to 15% K₂O, or 2.0 to 7.2% K₂O. In some embodiments, the composition comprises, by weight, 0% K₂O or more, 1% K₂O or more, or 2.0% K₂O or more. In some embodiments, the composition comprises, by weight, 30% K₂O or less, 15% K₂O or less, or 7.2% K₂O or less.

In some embodiments, the composition of the glassy element comprises, by weight, 0 to 30% YO, 0.1 to 5% YO, or 0.5 to 1.0% YO, wherein Y is selected from Ca, Mg, Ba, optionally Y is Ca and/or Mg.

Unavoidable impurities herein are impurities, which may be contained in the educts, e.g. Fe, Ti, Zn, Cu, Mn, Co. Optionally, the total amount of all unavoidable impurities is 5 mass-% or less, optionally 2.5 mass-% or less, optionally 1.0 wt.-% or less, optionally 0.5 wt.-% or less, optionally 0.1 mass-% or less, optionally 0.01 wt.-% or less.

The inventive glassy elements can be used in various applications. Such uses are covered by the inventions as well. An example is the use of the described glassy element in a method comprising a coating process, optionally wherein the coating process comprises a CVD process, optionally a PECVD, PICVD or PACVD process.

Another advantageous use of the glassy element, especially of a coated glassy element as described, is a container, especially a pharmaceutical glass container. Therein the coating properties can especially play a role in the interaction with the drugs to be contained. Of course the application on the outside of the container is possible as well, for example in order to improve the mechanical properties of the container, advantageously the scratch resistance.

Another advantageous use of the glassy element is as a substrate for further processing, optionally structuring. Therein the modified interface can beneficially interact with the structuring method or procedures.

TABLE 1a
Fiolax treatment

| | Untreated | Treated |
|---|---|---|
| | Atomic percent | Atomic percent |
| Element | [%] | [%] |
| Ca | 1.8 | 1.5 |
| Si | 84.6 | 87.6 |
| Al | 9.7 | 9.2 |
| Na | 3.9 | 1.7 |

For example, the method provided according to the invention was applied for a glassy element with the composition of a SCHOTT Fiolax glass, which is known to be used for glass tubes and/or pharmaceutical containers. The following table 1a shows how the atomic ration between relevant elements of the glass composition were altered by the described process for SCHOTT Fiolax, whereas an Ar plasma provided the kinetic interaction members.

As can be seen, the atomic ration of Na in the composition of the treated glassy element is drastically reduced, in this case by a factor of 2.3, meaning that the atomic ratio for Na in an untreated glassy element is 2.3 times bigger than in a treated glassy element. The atomic ratio for the other elements is nearly the same. In this example Na is a gap filler, which is mobilized by the described method, whereas Ca is strongly bound into or with the glass network structure and remains in the glassy element.

TABLE 1b
Borofloat 33 treatment

| | Untreated | Treated |
|---|---|---|
| | Atomic percent | Atomic percent |
| Element | [%] | [%] |
| K | 1.27 | 1.0 |
| Ca | 6.98 | 8.8 |
| Si | 65.08 | 64.4 |
| Al | 21.59 | 22.7 |
| Na | 5.08 | 3.1 |

The same principle measurement was applied for SCHOTT Borofloat 33, or called Boro 33 in the course of this description. The referring results are summarized in Table 1b. As can be seen, Na was selectively removed from a glassy element's interface which was made from Borofloat 33 with a high efficiency, whereas K is present almost in an unchanged relation. Obviously, K is much stronger bound to the glass network structure of Borofloat 33. Again, an Ar plasma was applied, or in other words, the kinetic reaction members were represented by Ar ions.

The same selectiveness can be seen for other examples of glasses, whereas the atomic ratio might differ for other glasses. Obviously, this is dependent on how strong the bonding force of the gap fillers to the glass network structure is and which element really a gap filler is in the referring glass composition.

In the following Table 2 the concentration changes of relevant elements in the gradient area of glassy elements being composed of different known glass compositions are summarized, depending on different process gases.

The current description is focused on the physical effect achieved by the kinetic reaction members, as described in detail above. This is achieved by the application of an Ar plasma.

In Table 2 the column +/− indicates whether there is an increase of the referring element by the referring plasma treatment at the given depths from the interface, indicated by +, or an decrease, indicated by −. The depletion of elements is consequently indicated by a − followed by the depths in nm, in which the effect with the quoted quantity was measured.

In a Sodalime glass, Na, Ca and K are most efficiently removed from the interface. In a SCHOTT Borofloat 33 glass, mainly Na and K are removed by an Ar plasma. Whereas the Ca content seems to remain stable. In a SCHOTT LAS 80 glass, a lithium aluminum silicate glass, mainly Li is removed, whilst the other alkali metals are also removed, but less efficiently. The same assay of course applies for the referring oxides, as the perspective of the evaluation of a glass composition might be.

However, the data collected in Table 2 also gives raise to the assumption that by the application of other plasmas than Ar or other noble gases also other removal channels might occur for elements in substrate interfaces.

TABLE 2

| Glass | | TOF-SIMS: Concentration Change Element in Depth [nm] | | | | | | | | | | | |
|---|---|---|---|---|---|---|---|---|---|---|---|---|---|
| Type | Plasma | +/− | Na+ | +/− | Ca+ | +/− | K+ | +/− | Mg+ | +/− | Al+ | +/− | Si+ |
| Sodalime | NH₃ | − | 35 | − | 35 | | | − | 30 | + | 40 | − | 22 |
| | NH₃ + N₂ | − | 12 | − | 5 | | | | 0 | + | 20 | | 0 |
| | O₂ | + | 5 | − | 25 | | | | 0 | | 0 | | 0 |
| | Ar | − | 15 | − | 16 | − | 10 | | 0 | | 0 | | 0 |
| Boro 33 | NH₃ | − | 55 | + | 10 | | | + | 50 | + | 55 | − | 12 |
| | NH₃ + N₂ | − | 40 | | 0 | | | | 0 | + | 20 | | 0 |
| | O₂ | − | 40 | | 0 | | | | | − | 5 | | 0 |
| | Ar | − | 40 | | 0 | − | 25 | | 0 | | 0 | | 0 |
| LAS 80 | NH₃ | − | 8 | − | 8 | | | − | 60 | + | 10 | | 0 |
| | NH₃ + N₂ | | 0 | | 0 | | | − | 25 | | 0 | | 0 |
| | O₂ | | 0 | − | 25 | | | | 0 | | 0 | | 0 |
| | Ar | − | 7 | − | 8 | − | 4 | | | + | 10 | + | 8 |
| AS87 | NH₃ | − | 25 | | 0 | | | − | 5 | + | 20 | + | 20 |
| | NH₃ + N₂ | − | 5 | | 0 | | | | 0 | | 0 | | 0 |
| | O₂ | + | 25 | | 0 | | | − | 5 | − | 20 | − | 25 |

TABLE 2

| Glass | | TOF-SIMS: Concentration Change Element in Depth [nm] | | | | | | | | | |
|---|---|---|---|---|---|---|---|---|---|---|---|
| Type | Plasma | +/− | B+ | +/− | Li+ | +/− | O2− | +/− | H− | +/− | SiN |
| Sodalime | NH₃ | | | | | − | 30 | − | 60 | + | 40 |
| | NH₃ + N₂ | | | | | | 0 | − | 55 | + | 10 |
| | O₂ | − | 5 | | | | 0 | − | 60 | | 0 |
| | Ar | | | | | | 0 | − | 60 | | 0 |
| Boro 33 | NH₃ | − | 12 | | | | 0 | | 0 | + | 55 |
| | NH₃ + N₂ | | 0 | | | | 0 | + | 20 | + | 20 |
| | O₂ | | 0 | | | | 0 | | | | |
| | Ar | | 0 | | | | 0 | | | − | 55 |
| LAS 80 | NH₃ | | | | | | 0 | + | 30 | + | 15 |
| | NH₃ + N₂ | | | | | | 0 | + | 30 | | 0 |
| | O₂ | | | | | | 0 | − | 5 | | 0 |
| | Ar | | | − | 24 | | | | | | |
| AS87 | NH₃ | | | | | | 0 | − | 140 | + | 35 |
| | NH₃ + N₂ | | | | | | 0 | − | 140 | + | 5 |
| | O₂ | | | | | | 0 | − | 140 | | |

Such might also be physical interaction channels, but could also be or comprise chemical reaction channels. This might especially hold true for O₂ derived plasma, but also for nitrogen containing plasmas, such as NH₃ and/or NH₃+N₂. The combination of the referring and other plasmas can be used to selectively modify the interface of a glassy element.

Glass Element

In some embodiments, the invention provides a glass element comprising a volume area 4 and an interface area 5, wherein the interface area extends between 0 nm to 200 nm from a surface of the glass element substantially orthogonally towards the volume area, wherein the volume area has a distance of at least 200 nm from a surface of the glass element, wherein the glass element comprises a glass network structure and one or more gap fillers, wherein the glass network structure comprises Si, and optionally B and/or Al,

wherein the one or more gap fillers are selected from the list of Na and K,
characterized by one or more of the following properties:
the concentration of the one or more gap fillers in the interface area is different by a factor of at least 1.5 when compared to the volume area;
the gap filler is Na, wherein the concentration of Na in the interface area is depleted by a factor of at least 1.5, optionally a factor of at least 2.0, optionally a factor of at least 3.5, optionally a factor of at least 5.0, when compared to the volume area; and
the gap filler is K, wherein the concentration of K in the interface area is enriched by a factor of at least 1.5, optionally a factor of at least 2.0, optionally a factor of at least 3.5, optionally a factor of at least 5.0, when compared to the volume area.

In some embodiments of the glass element, the interface area extends between 5 nm to 150 nm, optionally between 20 nm to 100 nm, from a surface of the glass element orthogonally towards the volume area.

In some embodiments, the invention provides a glass element comprising a volume area 4 and an interface area 5, the glass element comprising a glass network structure and one or more gap fillers, wherein the glass network structure comprises Si, and optionally B and/or Al, wherein the one or more gap fillers are selected from the list of Na and K, wherein one or more of the following conditions is fulfilled:
the depth of leaching for Na into the interface area is at least 3 nm or more, 5 nm or more, 7 nm or more, or 9 nm or more; and
the depth of leaching for K into the interface area is at least 3 nm or more, 5 nm or more, 7 nm or more, or 9 nm or more.

In some embodiments, the invention provides a glass element comprising a surface and a bulk,
wherein the glass element comprises a glass network structure and one or more gap fillers,
wherein the glass network structure comprises Si, and optionally B and/or Al, wherein the one or more gap fillers are selected from the list of Na and K, characterized by one or more of the following properties:
   the concentration of the one or more gap fillers at the surface is different by a factor of at least 1.5 when compared to the bulk;
   the gap filler is Na, wherein the concentration of Na at the surface is depleted by a factor of at least 1.5, optionally a factor of at least 2.0, optionally a factor of at least 3.5, optionally a factor of at least 5.0, when compared to the bulk; and
   the gap filler is K, wherein the concentration of K at the surface is enriched by a factor of at least 1.5, optionally a factor of at least 2.0, optionally a factor of at least 3.5, optionally a factor of at least 5.0, when compared to the bulk.

Within the present disclosure the concentration of the one or more gap fillers at the surface may be understood as the concentration of the one or more gap fillers within the surface, which may be understood as the volume element of the surface multiplied or combined with its related depth.

Whereas in a strict reading the surface of the glass element refers to the interface between the glass material and a surround medium, such as e.g. vacuum, air, water or a buffer. The skilled person understands that in the context of the present invention the surface of the glass element has a certain depth or thickness and extends towards the bulk of the glass element. In this context, the bulk of the glass element shall be understood as the interior of the glass element which has uniform and isotropic properties with respect to the chemical composition and physical parameters. By contrast, within the surface of the glass element, the chemical composition may change and/or differ and physical parameters may be anisotropic.

The glass element comprises a glass network structure and one or more gap fillers, wherein the glass network structure comprises Si, and optionally B and/or Al, wherein the one or more gap fillers are selected from the list of Na and K. It is generally appreciated that the glass network structure comprises Si in the form of silicates. Depending on the glass type, such as e.g. in the case of borosilicates or alumosilicates, B and/or Al may be present and, together with Si, form the glass network structure via oxygen atoms as bridges. Silicates, borates and aluminium oxides require counter-ions, here referred to as gap fillers, such as e.g. Na and K.

In some embodiments of the glass element, the concentration of the one or more gap fillers at the surface is different by a factor of at least 1.5 when compared to the bulk, or a factor of at least 5.0, or a factor of at least 10.0. In some embodiments of the glass element, the concentration of the one or more gap fillers at the surface is different by a factor of 100 or less, when compared to the bulk, or a factor of 50 or less, or a factor of 20 or less. The difference in the concentration of the one or more gap fillers at the surface by a factor covers both enrichment and depletion of the respective gap filler(s) at the surface when compared to the bulk.

In some embodiments of the glass element, the gap filler is Na, wherein the concentration of Na at the surface is depleted by a factor of at least 1.5, optionally a factor of at least 2.0, optionally a factor of at least 3.5, optionally a factor of at least 5.0, when compared to the bulk. In some embodiments, the concentration of Na at the surface is depleted by a factor of 20.0 or less, a factor of 15.0 or less, or a factor of 10.0 or less, when compared to the bulk. In some embodiments, the concentration of Na at the surface is depleted by a factor between 1.5 and 20.0, 3.5 and 15.0, or 5.0 and 10.0.

In some embodiments of the glass element, the gap filler is K, wherein the concentration of K at the surface is enriched by a factor of at least 1.5, optionally a factor of at least 2.0, optionally a factor of at least 3.5, optionally a factor of at least 5.0, when compared to the bulk. In some embodiments, the concentration of K at the surface is enriched by a factor of 20.0 or less, 15.0 or less, or 10.0 or less, when compared to the bulk. In some embodiments, the concentration of K at the surface is enriched by a factor between 1.5 and 20.0, 3.5 and 15.0, or between 5.0 and 10.0, when compared to the bulk.

Advantageously, the glass elements provided according to the invention display an altered concentration of one or more gap fillers, e.g. Na and K, which may contribute to the chemical resistance and provide for improved physical surface properties of the glass elements.

In some embodiments of the glass element, the surface extends towards the bulk, wherein the surface has a depth of 200 nm or less, 150 nm or less, or 100 nm or less. It may be understood that the surface is modified according to the means of the invention and that the altered chemical and physical properties manifest themselves up to a certain depth towards the bulk of the glass element. The skilled person understands that the provided methods of physical vapor deposition (PVD) and chemical vapor deposition (CVD), including but not limited to PECVD, PICVD and PACVD, allow surface modification of the glass element. The skilled person also knows that, as part of the present disclosure, the underlying process parameters can be steered to control the type and depth of surface modification.

In some embodiments, the invention provides a glass element comprising a surface and a bulk, wherein the surface extends towards the bulk, the glass element comprising a glass network structure and one or more gap fillers, wherein the glass network structure comprises Si, and optionally B and/or Al, wherein the one or more gap fillers are selected from the list of Na and K, wherein one or more of the following conditions is fulfilled:
Na is depleted at the surface, wherein the Na depletion at the surface has a depth of 3 nm or more, 5 nm or more, 9 nm or more, 12 nm or more, or 15 nm or more; and
K is depleted in the surface, wherein the K depletion into the surface has a depth of 2 nm or more, 3 nm or more, 5 nm or more, or 15 nm or more.

As explained within this disclosure, PVD and CVD, e.g. PECVD, PICVD and PACVD, allow surface modification of the glass element providing for a depletion or enrichment of certain glass (element) species. The ToF-SIMS technique provides an analytical tool which is based on the erosion of a surface by a sputter ion-beam. The secondary ions produced by the primary ion beam are extracted from the surface and detected by mass separation. ToF-SIMS thereby allows to generate depth profiles which provide information on the qualitative surface composition for different ion or elemental species.

In some embodiments of the glass element, Na is depleted at the surface, wherein the Na depletion at the surface has a depth of 3 nm or more, 5 nm or more, 9 nm or more, 12 nm or more, or 15 nm or more. In some embodiments, Na is depleted at the surface, wherein the Na depletion at the surface has a depth of 100 nm or less, 70 nm or less, 50 nm or less, 40 nm or less, or 30 nm or less. In some embodiments, Na is depleted at the surface, wherein the Na depletion at the surface has a depth between 3 nm and 100 nm, between 5 nm and 70 nm, between 9 nm and 50 nm, between 12 nm and 40 nm, or between 15 nm and 30 nm.

In some embodiments of the glass element, K is depleted in the surface, wherein the K depletion into the surface has a depth of 2 nm or more, 3 nm or more, 5 nm or more, or 15 nm or more. In some embodiments, K is depleted at the surface, wherein the K depletion at the surface has a depth of 100 nm or less, 70 nm or less, 50 nm or less, or 30 nm or less. In some embodiments, K is depleted at the surface, wherein the K depletion at the surface has a depth between 2 nm and 100 nm, between 3 nm and 70 nm, between 5 nm and 50 nm, or between 15 nm and 30 nm.

Container

In some embodiments, the invention provides a container comprising the glass element or the glassy element provided according to the invention.

In some embodiments, the container may be a syringe, a vial, a tube or an ampoule.

There are several ways to design and further develop the teachings of the present invention in an advantageous way. To this end, it is to be referred to the patent claims subordinate to the independent patent claims on the one hand and to the following explanation of examples of embodiments provided according to the invention, illustrated by the figures; and the attached items on the other hand. In connection with the explanation of the exemplary embodiments provided according to the invention by the aid of the figures, generally exemplary embodiments and further developments of the teaching will be explained:

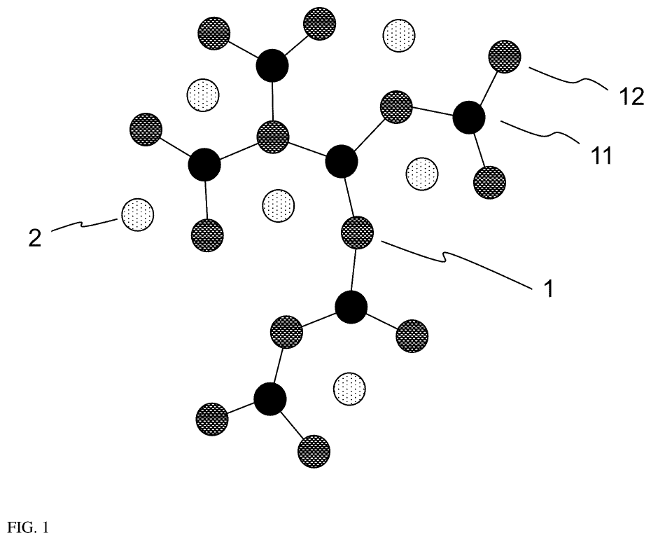

Referring specifically now to the drawings, FIG. 1 schematically shows the glass network structure in a principle view. There is a network structure 1 which in this case forms some kind of mesh, and there are gap fillers 2 which are located in the gaps of said mesh. In this example, the glass network might be formed of Si and O, whereas the gap fillers might be Na. According to the invention, the gap fillers are mobilized e.g. by heating and then at least partially removed from the network by interaction with the kinetic interaction members, e.g. by an impulse transfer.

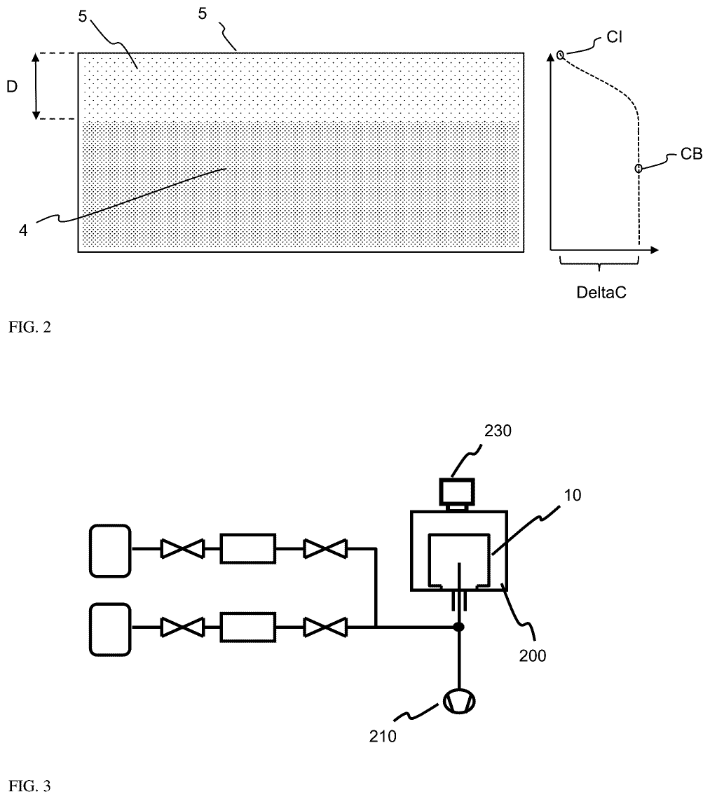

In FIG. 2 the schematic cut through an exemplary glassy element provided according to the invention is shown. The glassy element has a bulk 4 or volume area with a glass network structure and gap fillers. Near the interface there is a gradient area 5, in which gap fillers are not present or where the concentration of gap fillers is reduced when compared to the bulk area.

On the right side of FIG. 2 the concentration profile of the gap fillers is schematically shown. The concentration CI of gap fillers at the interface is lower than the concentration CB of gap fillers in the bulk. The difference of the maximum and minimum concentration of gap fillers is DeltaC.

FIG. 3 shows the schematics of an apparatus for performing the described method. The glassy element 10, in this case for example a vial, is located in the reaction chamber 200 which can be evacuated with the vacuum pump 210. The microwave or radiowave generator 230 is attached to the reaction chamber in order to ignite a plasma of the heating or processing gas.

The process gas containing or consisting of the kinetic reaction members can be fed to the reaction chamber from a storage vessel and valves. Another storage vessel can contain the heating gas, which can be fed to the reaction chambers via valves as well. This way the reaction chamber can be evacuated, filled with the desired pressure of heating gas, and the irradiated with radiation originating from the microwave or radiowave generator in order to generate a heating gas plasma. As described, especially if the heating gas is O₂ or contains nitrogen, the interface of the glassy element can be pretreated.

The procedure is usually performed until the glassy element has the desired temperature. Then the heating gas can be removed from the reaction chamber by the vacuum pump. The process gas can then be introduced to the reaction chamber, where again a plasma is ignited which as effect creates the kinetic interaction members and/or provides those with their kinetic energy and thereby exposes the glassy element's interface to the said kinetic interaction members.

At the end of the process, the process gas can be removed and the reaction chamber can be filled with normal atmosphere in order to allow the now treated glassy element to be removed from the reaction chamber.

As can be easily seen, the shown apparatus has the advantage that the heating of the glassy element with heating gas and the treatment of the glassy element's interface with the kinetic interaction members can be performed in one reaction chamber without the need for transporting the glassy element from one reaction chamber for heating (or pre-treatment) and then to another reaction chamber for the treatment with the kinetic interaction members.

As also described, it is of course possible to additionally or alternatively heat the glassy element during the treatment with the kinetic interaction members with a heating element, which might be in contact with the glassy element and/or might irradiate the glassy element with IR radiation.

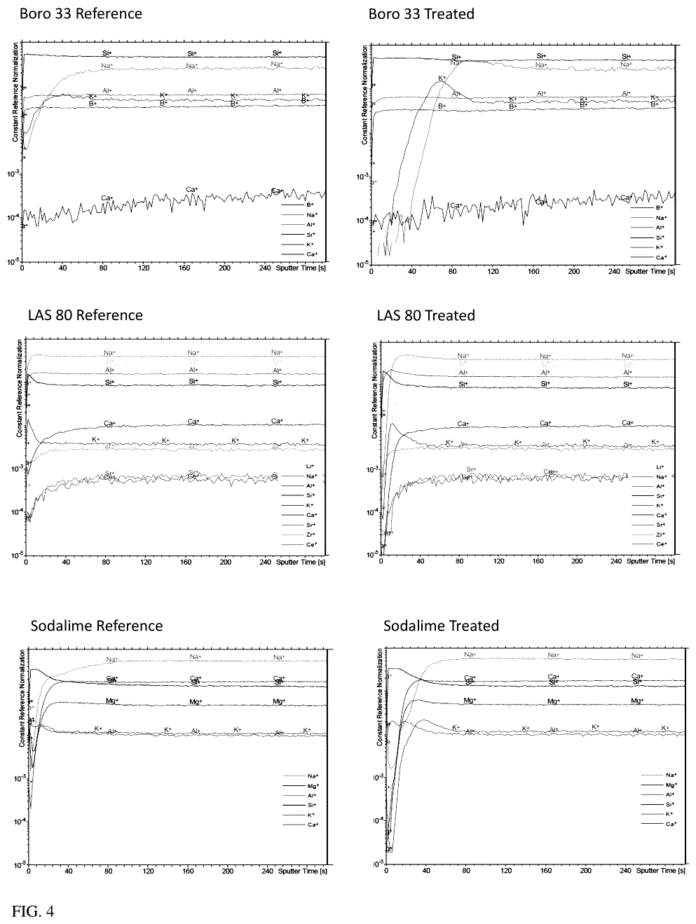

In FIG. 4, the concentration changes for relevant elements of different glass compositions are shown in comparison to the untreated reference when applying the described microwave plasma process. Here, an Ar plasma was used for the exposition of the glassy element with the kinetic interaction members.

The curves show the result of a TOF-SIMS measurement. As can be seen, in a SCHOTT Borofloat 33 glass the concentration of Na and K are decreased in the interface area, whose depth correlates with the sputter time, which is shown in x-direction of the graph. The concentration of Si, Al and B remains the same, supporting the observation that the glass network structure remains unchanged by the process, but the gap fillers Na and K are depleted.

A similar observation can be drawn from the measurement of a LAS 80 glass. Here, Li, Na and Ca loose concentration near the interface, whereas K remains more unchanged. Probably K is stronger bound to the LAS 80 glass network. As can be seen as well, the concentration change occurs much earlier than in the Borofloat 33, which meant that those component are either more loosely bound, resulting in an earlier depletion by the TOF-SIMS analysis, or that the removal occurs only closer to the interface.

In a Sodalime glass, Na and K and Mg are predominantly depleted from the glass network, whereas Ca and Al mostly remain unchanged.

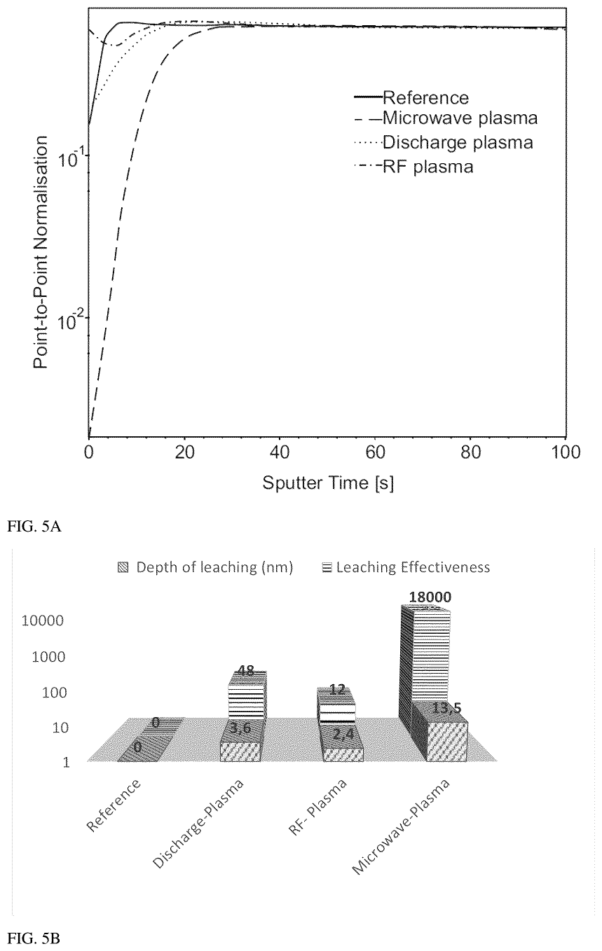

In FIGS. 5A to 8B, the results of further TOF-SIMS measurements are shown, wherein glasses are treated with a discharge plasma, radio-frequency plasma and a microwave plasma, and compared to reference treatment.

FIGS. 5A, 6A, 7A, and 8A display the TOF-SIMS raw data.

FIGS. 5B, 6B, 7B, and 8B display the Na leaching or K leaching, as applicable.

FIGS. 5A and 5B show TOF-SIMS measurements for a soda-lime glass, and Na leaching in the interface area.

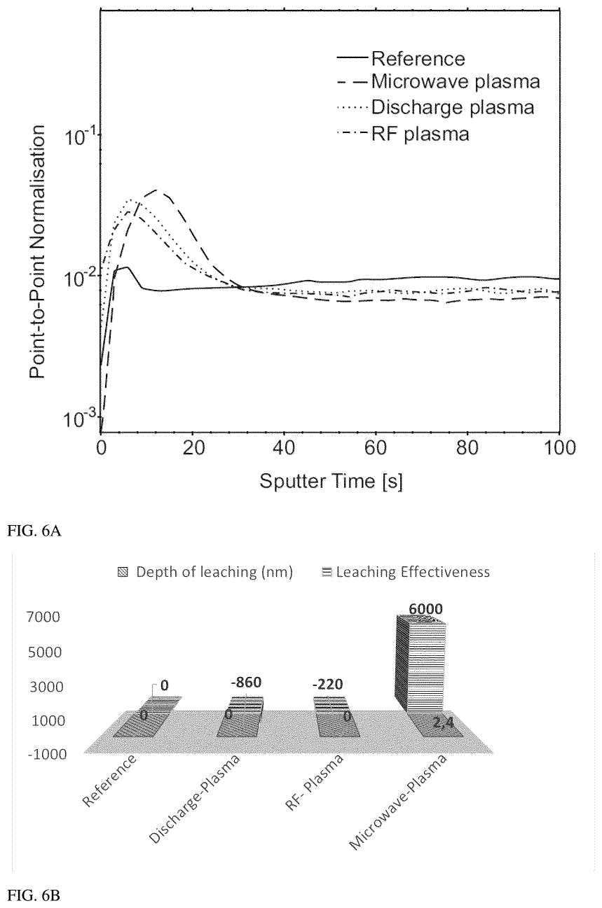

FIGS. 6A and 6B show TOF-SIMS measurements for a soda-lime glass, and K leaching in the interface area.

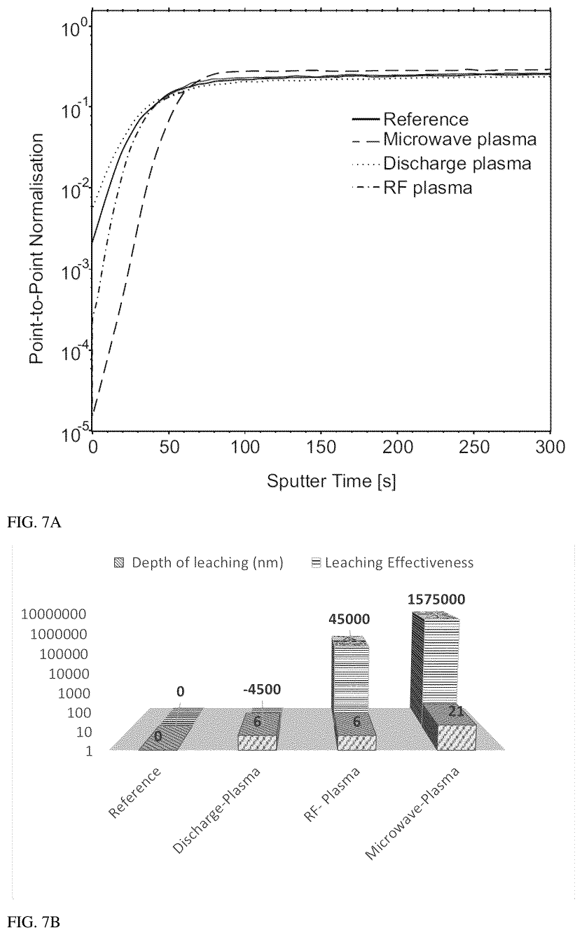

FIGS. 7A and 7B show TOF-SIMS measurements for a borosilicate glass, and Na leaching in the interface area.

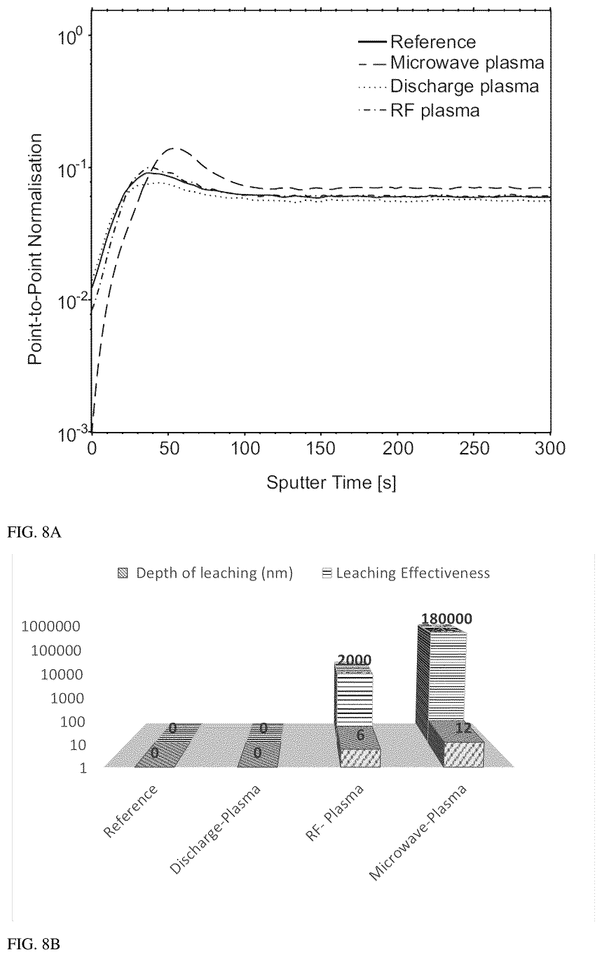

FIGS. 8A and 8B show TOF-SIMS measurements for a borosilicate glass, and K leaching in the interface area.

In a soda-lime glass, irrespective of the employed plasma method, Na depletion is observed at the glass surface. The most predominant depletion of Na from the glass network is observed after discharge plasma treatment. K enrichment is observed at the glass surface.

In a borosilicate glass, Na depletion is observed at the glass surface. Using discharge plasma, Na depletion is most pronounced over the other plasma methods, causing Na depletion into a depth of 25 nm. For K, initially a depletion is observed near the glass surface. At a depth of 20 nm, K enrichment is observed. The concentration of Si and B remains fairly constant, supporting the notion that the glass network structure in a borosilicate glass remains unchanged by the process, but the gap fillers Na and K are subject to changes. In summary these analyses show that the described method allows a selective depletion of elements form a glassy element's interface, whereas the other elements obviously remain in the glass unchanged. The method allows to adopt to the behavior of different glass network structures and thereby is applicable for different glass types.

As example for a procedure, a glassy element was prepared by the described method in a plasma treatment device which comprises a reaction chamber, in which the unprocessed glassy element is placed and which can be subjected to a reduced pressure atmosphere. The electromagnetic radiation can fill the reaction chamber and/or processing gases can be introduced into the reaction chamber and ignited as plasma, for example as effect of the electromagnetic radiation. The kinetic interaction members may be provided with their kinetic energy as effect of the plasma ignition and further interactions.

### Examples

Treatment: Discharge plasma, radio-frequency plasma, microwave plasma

Glass elements were plasma-treated with Argon using a discharge plasma, radio-frequency plasma, or microwave plasma, and compared to a reference (treatment).

Discharge plasma: atmospheric pressure, room temperature (optionally 20° C.), and 100 to 5000 W.

Radio-frequency plasma: 0.01 mbar up to 10 mbar, room temperature to 300° C., 10 to 600 W.

Microwave plasma: 0.01 mbar to 10 mbar, room temperature to 300° C., 1000 W to 10.000 W.

Soda-Lime and Borosilicate Glass

The used soda-lime and borosilicate glass compositions fulfil the following composition range.

| wt. % | minimum | maximum |
|---|---|---|
| SiO₂ | 50.00 | 85.00 |
| Al₂O₃ | 0.00 | 30.00 |
| B₂O₃ | 0.00 | 20.00 |
| Li₂O | 0.00 | 15.00 |
| Na₂O | 0.00 | 20.00 |
| K₂O | 0.00 | 20.00 |

ToF-SIMS

The ToF-SIMS technique is based on the erosion of a surface by a sputter ion-beam. The secondary ions produced by the primary ion beam are extracted from the surface and detected by mass separation. The generated depth profiles provide information on the qualitative surface composition for different ion species.

ToF-SIMS (Time-of-Flight Secondary Ion Mass Spectrometry) measurements were performed according to ASTM E 1829 and ASTM E 2695, using a TOF-SIMS IV (ION-TOF GmbH) instrument. The following analysis parameters were used: primary ion: Ga; Energy: 25 keV; currents were measured in pA, area 50×50 μm², PIDD is quantified in ions/cm². The following sputter parameters were used: SpI: O₂, Energy: 1 keV, currents were measured in nA, area 300×300 μm², SpIDD is quantified in ions/cm².

Sputter rates and sputter depths were estimated by comparison to reference measurements on a ceramic glass. Depth profiles with positive polarity were normalised to Si⁺. Depth profiles with negative polarity were normalised to Si⁻. The depletion rate at positive polarity was about 0.3 nm/s.

Leaching

A soda-lime and a borosilicate glass were subjected to treatment with discharge plasma, radio-frequency plasma, and microwave plasma, and compared to a reference treatment. The depth of leaching and the leaching effectiveness were quantified for K⁺ and Na⁺ ions from the soda-lime and the borosilicate glass. The depth of leaching quantifies the depletion of K⁺ and Na⁺ ions at or near the surface as compared to the bulk of the glass element.

Depth profiles with positive polarity were normalised to Si⁺. Depth profiles with negative polarity were normalised to Si⁻. The stripping rate at positive polarity was about 0.3 nm/s.

The leaching effectiveness of a plasma process was calculated based on the ToF-SIMS measurements. The area between the reference measurement and the measurement based on a plasma-treatment provides a quantification of the leaching effectiveness. If the calculated area is negative, the respective ion is enriched on the surface. If the calculated area is positive, the respective ion is depleted from the surface.

As leaching refers to a decrease of a desired ion in the glass matrix, leaching effectiveness is defined by the area which is below the curve of the reference sample. The area above the reference measurement is assigned a negative value which represents an increase of the respective ion on the surface and represents an enrichment.

The leaching depth was quantified as the product of the factor 0.3 nm s⁻¹ and the time point of the sputter time (in s) when the reference and the treatment curve intersect.

### Exemplary Embodiments

The invention can be summarized by the following items or exemplary embodiments (the combination of two or more; e.g. 2, 3, 4, 5, 6 or 7; items may be advantageous). The following items also represent embodiments provided according to the invention, which can be combined with any property, definition, measuring method and/or any further disclosure described herein.

Method for providing a glassy element comprising the steps:
providing a glassy element comprising a glass mesh structure and gap fillers at least at an interface area;
   heating the glassy element to a temperature T, which is optionally below Tg, whereas the gap fillers are mobilized in relation to the glass network structure;
   exposing at least a interface area of the glassy element to kinetic interaction members having an kinetic energy, whereby the kinetic interaction members interact with the gap fillers, whereby gap fillers are removed from glass mesh structure.

In some embodiments, a method for providing a glass element comprises the steps:
providing a glass element having a surface;
heating the glass element to a temperature T, which is optionally below Tg;
employing a plasma process, optionally a pulsed plasma process, wherein the plasma process is selected from discharge plasma, radio-frequency plasma and microwave plasma;
exposing at least a part of the surface of the glass element to a plasma, wherein the plasma is generated from O₂, N₂ or a noble gas selected from Ar, He, Ne, Kr and/or Xe.

In some embodiments, a method for providing a glass element comprises the steps:
providing a glass element having a surface;
heating the glass element to a temperature T, which is optionally below Tg;
employing a radio-frequency plasma process;
exposing at least a part of the surface of the glass element to a plasma, wherein the plasma is generated from O₂ and/or N₂.

In some embodiments, a method for providing a glass element comprises the steps:
providing a glass element having a surface;
heating the glass element to a temperature T, which is optionally below Tg;
employing a radio-frequency plasma process;
exposing at least a part of the surface of the glass element to a plasma, wherein the plasma is generated from a noble gas selected from Ar, He, Ne, Kr and/or Xe, optionally the plasma is generated from Ar.

In some embodiments, a method for providing a glass element comprises the steps:
providing a glass element having a surface;
heating the glass element to a temperature T, which is optionally below Tg;
employing a plasma process, optionally a pulsed plasma process, wherein the plasma process is selected from discharge plasma, radio-frequency plasma and microwave plasma;
exposing at least a part of the surface of the glass element to a plasma, wherein the plasma is generated from Ar.

Method provided according to any one of the preceding items, wherein the glass network structure at the interface of the glassy element being exposed to the kinetic interaction members remains unchanged when compared to the glass network structure within the volume of the glass element.

Method provided according to any one of the preceding items, wherein the glass network structure comprises Si bonds, which are preserved during the exposition with the kinetic interaction members.

Method provided according to any one of the preceding items, wherein the kinetic interaction members are selected from the group of noble gases or noble gas ions, such as Ar, Ar ions, He, He ions, Ne, Ne ions, Kr, Kr ions and/or Xe and/or Xe ions, including any combinations thereof.

In some embodiments, the plasma is generated from a noble gas comprising Ar, He, Ne, Kr, and/or Xe, including any combinations thereof.

Method provided according to any one of the preceding items, wherein during exposition of the glassy element with the kinetic interaction members no chemical reactive species are exposed to the glassy element.

Method provided according to any one of the preceding items, whereas the gap fillers are alkaline metals and/or earth alkaline metals, such as Li and/or Na and/or K and/or Cs and/or Mg and/or Ca and/or Sr and/or Ba including the respective oxides thereof.

Method provided according to any one of the preceding items, whereas the removal of gap fillers results in a gradient area within the glassy element in which the concentration of the gap fillers is reduced when compared to an area outside the gradient area; usually the gradient area extends from the interface of the glassy element into its depth; usually the gradient area has a thickness of about 200 nm.

Method provided according to any one of the preceding items, wherein the kinetic interaction members are directed to the interface of the glassy element as effect of having a velocity with a vector pointing towards the respective interface area of the glassy elements, optionally the kinetic reaction member is a plasma of the noble gases mentioned in item or are directed to the respective interface area of the glassy element by an ion gun.

Method provided according to any one of the preceding items, wherein a lower than atmospheric pressure is applied at least during the exposition of the glassy element with the kinetic interaction members; optionally the method is a low pressure plasma process.

Method provided according to any one of the preceding items, wherein the heating of the glassy element is achieved by exposing the glassy element to a heating device; optionally the heating device is in direct contact with the glassy element or irradiates the glassy element with optionally IR radiation.

Method provided according to any one of the preceding items, wherein the heating of the glassy element is at least partially achieved by exposing the glassy element to heating gas; optionally a heating gas plasma; optionally a plasma comprising or consisting of O₂ and/or oxygen ions and/or N₂ or nitrogen ions.

In some embodiments, the plasma is generated from O₂ and/or N₂.

Method provided according to the previous item, wherein the exposition of the glassy element with the heating gas and/or heating gas plasma results in a pretreatment of the glassy element's interface.

Method provided according to any one of the preceding items, wherein during the exposition of the glassy element with the kinetic interaction members no heating gas is present in the surrounding atmosphere.

Method provided according to any one of the preceding items, wherein the heating of the glassy element with the heating gas is performed prior to the exposition of the glassy element with the kinetic interaction members; optionally the glassy element is heated by the exposition with the heating gas, then the heating gas is removed from the surrounding atmosphere, then the surrounding atmosphere is introduced to comprise or consist of the kinetic interaction members, then energy is transferred to the kinetic interaction members to expose the glassy element with kinetic interaction members.

Method provided according to any one of the preceding items, wherein providing the kinetic interaction members with energy is achieved by the ignition of a plasma of a gas comprising or consisting of the kinetic interaction members; optionally the exposition of the glassy element with kinetic interaction members is a plasma process; optionally a pulsed plasma process.

Method provided according to any one of the preceding items, wherein the kinetic interaction members are present in form of a process gas, which does not contain a chemically reactive species for the glassy element's interface.

Method provided according to any one of the preceding items, wherein providing the heating gas with energy is achieved by the ignition of a plasma of a gas comprising or consisting of the heating gas; optionally the exposition of the glassy element with the heating gas is a plasma process; optionally a pulsed plasma process.

Method provided according to any one of the preceding items, wherein the plasma process is a pulsed plasma process, optionally in sequences of pulse time and pause time; optionally the pause time is greater than the pulse time.

Method provided according to any one of the preceding items, whereas the heating of the glassy element and/or the exposition with the kinetic energy members is performed at the process temperature PT1, which is 80° C. to Tg of the glass of the glassy element, optionally 80° C. to 500° C., optionally 120° C. to 450° C., optionally 150° C. to 320° C., optionally 160° C. to 300° C., optionally 160° C. to 195° C.

In some embodiments, the method is performed at a process temperature PT1, which is 80° C. to Tg of the glass of the glassy element, optionally 80° C. to 500° C., optionally 120° C. to 450° C., optionally 150° C. to 320° C., optionally 160° C. to 300° C., optionally 160° C. to 195° C.

Method provided according to any one of the preceding items, wherein the heating of the glassy element and/or the providing the kinetic reaction members with kinetic energy is achieved by irradiation by a microwave generator, optionally wherein the microwave has a frequency of 300 MHz to 300 GHz, optionally 600 MHz to 100 GHz, optionally 800 MHz to 10 GHz, optionally 900 MHz to 3 GHz, optionally 2.45 GHz.

In some embodiments of the method, the plasma is generated with a microwave generator, optionally wherein the microwave has a frequency of 300 MHz to 300 GHz, optionally 600 MHz to 100 GHz, optionally 800 MHz to 10 GHz, optionally 900 MHz to 3 GHz, optionally 2.45 GHz.

Method provided according to any one of the preceding items, wherein the kinetic interaction members achieve their kinetic energy as effect of a pulsed plasma with the pulse duration PD1; optionally the pulse duration PD1 of the plasma 20 μs or less, optionally 15 μs or less, optionally 12 μs or less, optionally 8 μs or less, optionally 6 μs or less, optionally 4 μs or less, optionally 2 μs or 3 μs; and/or

wherein the pulse duration PD1 of the plasma is 0.1 μs or more, optionally 0.5 μs or more, optionally 1 μs or more, optionally 6 μs or more.

In some embodiments of the method, the plasma is generated with a pulsed plasma with a pulse duration PD1 of 0.1 μs to 20 μs, 0.5 μs to 15 μs, 1 μs to 12 μs, or 2 μs to 8 μs.

Method provided according to any one of the preceding items, wherein the input power IP1 of the radiation generator, optionally the input power IP1 of the microwave generator for the microwave irradiation, is 1000 W to 10000 W, optionally 2100 W to 8000 W, optionally 2500 W to 6700 W, optionally 3000 W to 6000 W, optionally 3200 W to 5500 W, optionally 4000 W to 5000 W.

Method provided according to any one of the preceding items,
wherein the heating of the glassy element as well as providing the kinetic reaction members with kinetic energy is achieved by a plasma process, comprising the steps:
a) surrounding the at least part of the interface of the glassy element with a precursor P1 of at least the kinetic reaction member; and
b) irradiating the precursor P1 to generate a plasma;
   wherein at least one, optionally all, of the following parameters is/are fulfilled:
i) wherein the temperature of the glassy element is 80° C. to Tg of the glass of the glassy element, optionally 100° C. to to 500° C., optionally 150° C. to 450° C., optionally 180° C. to 350° C., optionally 180° C. temperature to 300° C.; and/or
ii) wherein the pulse duration PD1 of the plasma is 50 ms or less, optionally 40 ms or less, optionally 30 ms or less, optionally 20 ms or less, optionally 15 ms or less, optionally 8 ms or less, optionally 6 ms or less, optionally 2 ms, optionally 1 ms or less, optionally 0.5 ms; and/or
iii) wherein the pulse duration PD1 of the plasma is 0.1 ms or more, optionally 0.2 ms or more, optionally 0.3 ms or more, optionally 0.5 ms or more; and/or
iv) wherein the irradiation is carried out by a microwave generator, optionally wherein the ray has a frequency of 300 MHz to 300 GHz, optionally 600 MHz to 100 GHz, optionally 800 MHz to 10 GHz, optionally 900 MHz to 3 GHz, optionally 2.45 GHz; and/or
v) wherein the input power IP1, optionally the input power IP1 of the microwave generator, is 1000 W to 10000 W, optionally 2500 W to 8000 W, optionally 4000 W to 8000 W, optionally 5000 W to 7000 W, optionally 5000 W to 6500 W, optionally 5250 W to 5750 W; and/or
vi) the precursor P1 comprises noble gas and/or nitrogen, optionally; and/or
vii) wherein the precursor P1 comprises, optionally consists of, the elements He, Ne, Ar, Kr and/or Xe;
viii) the pulse pause PP1 between two pulses is 1 μs or more, optionally 10 μs or more, optionally 1 μs to 5 s, optionally 0.1 ms to 10 ms, optionally 0.5 ms to 2.0 ms, optionally 1.5 ms to 2.0 ms, optionally 1.8 ms; and/or
ix) the total time TT1 of irradiation is 0.1 s or more, optionally 1 s or more, optionally 1 s to 5 min, optionally 5 s to 15 s; and/or
x) the ratio [ms/ms] of all pulse durations PD1 [ms] to all pulse pauses PP1 [ms] is 0.05 or more, optionally 0.1 or more, optionally 0.15 to 5, optionally 0.2 to 0.5; and/or
xi) wherein the process pressure PR1 is 0.01 mbar to 500 mbar, optionally 0.1 mbar to 100 mbar, optionally 0.5 mbar to 10 mbar, optionally 0.8 mbar to 6.0 mbar, optionally 1.0 mbar to 4.0 mbar; and/or
xii) wherein the process temperature PT1 is increasing, optionally steadily increasing, during the plasma pretreatment; and/or
xiii) wherein the process temperature PT1 is at least partially, optionally at the time when the plasma pretreatment process ends, 80° C. or more, optionally 100° C. or more, optionally 150° C. or more, optionally 180° C. or more, optionally less than 200° C.; and/or
xiv) wherein the flow rate of the precursor P1 is 0.1 to 500 sccm, optionally 5 to 400 sccm, optionally 50 to 400 sccm, optionally 100 to 300 sccm.

In some embodiments of the method, the plasma process comprises the steps:
a) exposing the surface of the glass element to a precursor P1; and
b) irradiating the precursor P1 to generate a plasma;
wherein one or more of the following parameters is/are fulfilled:
i) wherein the temperature of the glassy element is 80° C. to Tg of the glass of the glassy element; and/or
ii) wherein the pulse duration PD1 of the plasma is 0.1 ms to 50 ms or less; and/or
iii) wherein the irradiation is carried out by a microwave generator, having a frequency of 300 MHz to 300 GHz; and/or
v) wherein the input power IP1 of the microwave generator is 1000 W to 10000 W; and/or
vi) the precursor P1 comprises a noble gas, optionally Ar, and/or nitrogen; and/or
vii) the pulse pause PP1 between two pulses is 0.1 ms to 10 ms; and/or
ix) the total time TT1 of irradiation is 1 s to 5 min; and/or
x) the ratio [ms/ms] of all pulse durations PD1 [ms] to all pulse pauses PP1 [ms] is 0.05 to 5; and/or
xi) wherein the process pressure PR1 is 0.01 mbar to 500 mbar; and/or
xii) wherein the process temperature PT1 is increasing, optionally steadily increasing, during the plasma pretreatment; and/or
xiii) wherein the process temperature PT1 is at least partially 80° C. or more; and/or
xiv) wherein the flow rate of the precursor P1 is 0.1 to 500 sccm.

In some embodiments of the method, the plasma process is performed such that the temperature of the glassy element is 80° C. to Tg of the glass of the glassy element, optionally 100° C. to 500° C., optionally 150° C. to 450° C., optionally 180° C. to 350° C., optionally 180° C. to 300° C.

In some embodiments of the method, the plasma process employs a pulse duration PD1 of 50 ms or less, optionally 40 ms or less, optionally 30 ms or less, optionally 20 ms or less, optionally 15 ms or less, optionally 8 ms or less, optionally 6 ms or less, optionally 2 ms, optionally 1 ms or less, optionally 0.5 ms

In some embodiments of the method, the plasma process employs a pulse duration PD1 of the plasma of 0.1 ms or more, optionally 0.2 ms or more, optionally 0.3 ms or more, optionally 0.5 ms or more

In some embodiments of the method, the plasma process employs a microwave generator with a frequency of 300 MHz to 300 GHz, optionally 600 MHz to 100 GHz, optionally 800 MHz to 10 GHz, optionally 900 MHz to 3 GHz, optionally 2.45 GHz

In some embodiments of the method, the plasma process employs an input power IP1 of 1000 W to 10000 W, optionally 2500 W to 8000 W, optionally 4000 W to 8000 W, optionally 5000 W to 7000 W, optionally 5000 W to 6500 W, optionally 5250 W to 5750 W

In some embodiments of the method, the plasma process uses a precursor P1 comprising a noble gas and/or nitrogen.

In some embodiments of the method, the plasma process uses a precursor P1 comprising, optionally consisting of, one of the elements He, Ne, Ar, Kr and/or Xe.

In some embodiments of the method, the plasma process employ a pulse pause PP1 between two pulses is 1 μs or more, optionally 10 μs or more, optionally 1 μs to 5 s, optionally 0.1 ms to 10 ms, optionally 0.5 ms to 2.0 ms, optionally 1.5 ms to 2.0 ms, optionally 1.8 ms.

In some embodiments of the method, the plasma process employs a total time TT1 of irradiation is 0.1 s or more, optionally 1 s or more, optionally 1 s to 5 min, optionally 5 s to 15 s.

In some embodiments of the method, the plasma process uses a ratio [ms/ms] of all pulse durations PD1 [ms] to all pulse pauses PP1 [ms] is 0.05 or more, optionally 0.1 or more, optionally 0.15 to 5, optionally 0.2 to 0.5.

In some embodiments of the method, the plasma process uses a process pressure PR1 is 0.01 mbar to 500 mbar, optionally 0.1 mbar to 100 mbar, optionally 0.5 mbar to 10 mbar, optionally 0.8 mbar to 6.0 mbar, optionally 1.0 mbar to 4.0 mbar.

In some embodiments of the method, the plasma process uses a process temperature PT1 which is increasing, optionally steadily increasing, during the plasma pretreatment.

In some embodiments of the method, the plasma process uses a process temperature PT1 which is at least partially, optionally at the time when the plasma pretreatment process ends, 80° C. or more, optionally 100° C. or more, optionally 150° C. or more, optionally 180° C. or more, optionally less than 200° C.

In some embodiments of the method, the plasma process uses a flow rate of the precursor P1 of 0.1 to 500 sccm, 5 to 400 sccm, 50 to 400 sccm, or 100 to 300 sccm.

Method provided according to any one of the preceding items, wherein the heating of the glassy element is performed in an atmosphere of the kinetic interaction members by a heating element.

Method provided according to any one of the preceding items, wherein the heating of the glassy element with a heating gas is performed before exposing the glassy element with kinetic interaction members by
a) surrounding the at least part of the interface of the glassy element with a precursor of the heating gas member; and
b) irradiating the precursor of the heating gas to generate a plasma;
c) removing the heating gas and/or the heating gas plasma from the atmosphere after or when a desired temperature of the glassy element is achieved;
d) surrounding the at least part of the interface of the glassy element with a precursor of the kinetic reaction members; and
e) irradiating the precursor of the kinetic interaction members to generate a plasma.

Glassy element, optionally obtainable by a method provided according to any one of the preceding items,
wherein the glassy element has at a least a volume area and at least one interface area;
wherein the glassy elements comprise a glass mesh structure and gap fillers within the volume area, whereby the concentration of gap fillers within the at least one volume area is CV;
wherein the glassy element comprises the same or at least predominantly the same glass mesh structure at the interface area as in the volume area;
optionally the glass mesh structure is the same in the interface areas as in the volume area;
wherein (in the interface region the gap fillers are leached out from glass mesh structure, so that) the concentration CI of the gap fillers in the interface area is lower than the concentration CV of gap fillers within the volume area.

Glassy element provided according to the preceding item, wherein the glass mesh structure is the same in the volume area as in the interface area; optionally the glass mesh structure comprises Si bonds coordinated to other components in a Si bond structure, wherein the Si bond structure in the volume area is the same as in the interface area.

Glassy element provided according to any one of the preceding items, wherein the gap fillers are alkaline metals and/or earth alkaline metals, such as Li and/or Na and/or K and/or Cs and/or Mg and/or Ca and/or Sr and/or Ba.

Glassy element provided according to any one of the preceding items, wherein the interface area there is a gradient in which the concentration of the gap fillers is reduced when compared to an area outside the gradient area; usually the gradient area extends from the interface of the glassy element into its depth; usually the gradient area has a thickness of about 200 nm or 100 nm or 80 nm or 50 nm or from 10 nm to 20 nm nm.

Glassy element provided according to any one of the preceding items, wherein a coating and/or coating system is applied on top of the interface area; optionally the coating interacts with the interface area on due to chemical and/or physical interaction.

Glassy element provided according to the preceding item, whereas the coating or coating system applied to the interface area has a higher adherence to the glassy element compared to the same coating or coating system applicable to an area outside the interface area.

Glassy element provided according to any one of the preceding items, wherein the glassy element has a glass composition of a soda lime glass or a borosilicate glass or an aluminosilicate glass or a lithium-aluminosilicate (LAS) glass, optionally a borosilicate glass.

Glassy element provided according to any one of the preceding items, wherein the composition of the glass comprises, in mass-%:
SiO₂: 30 to 98%, optionally 50 to 90%, optionally 70.0 to 74.0%; and/or
B₂O₃: 0 to 30%, optionally 3 to 20%, optionally 7.0 to 16.0%; and/or
Al₂O₃: 0 to 30%, optionally 1 to 15%, optionally 3.0 to 6.5%; and/or
X₂O: 0 to 30%, optionally 1 to 15%, optionally 2.0 to 7.2%, wherein X is selected from Na, K, Li, optionally X is Na and/or K; and/or
YO: 0 to 30%, optionally 0.1 to 5%, optionally 0.5 to 1.0%, wherein Y is selected from Ca, Mg, Ba, optionally Y is Ca and/or Mg.

Glassy element provided according to any one of the preceding items, wherein the composition of the glass consists of, in mass-%:
SiO₂: 30 to 98%, optionally 50 to 90%, optionally 70.0 to 74.0%;
B₂O₃: 0 to 30%, optionally 3 to 20%, optionally 7.0 to 16.0%;
Al₂O₃: 0 to 30%, optionally 1 to 15%, optionally 3.0 to 6.5%;
X₂O: 0 to 30%, optionally 1 to 15%, optionally 2.0 to 7.2%, wherein X is selected from Na, K, Li, optionally X is Na and/or K;
YO: 0 to 30%, optionally 0.1 to 5%, optionally 0.5 to 1.0%, wherein Y is selected from Ca, Mg, Ba, optionally Y is Ca and/or Mg; and unavoidable impurities.

Glassy element, according to any one of the preceding items, wherein the composition of the glass comprises, in mass-%:
SiO₂: 20 to 98%, optionally 40 to 75%, optionally 50 to 65%; and/or
B₂O₃: 0 to 30%, optionally 1 to 15%, optionally 3 to 9%; and/or
Al₂O₃: 0 to 30%, optionally 10 to 20%, optionally 13 to 18; and/or
X₂O: 0 to 30%, optionally 0 to 5%, optionally 0 to 3%, wherein X is selected from Na, K, Li, optionally X is Na and/or K; and/or
YO: 0 to 50%, optionally 0.1 to 40%, optionally 10 to 35, wherein Y is selected from Ca, Mg, Ba, optionally Y is Ca and/or Mg.

Glassy element provided according to any one of the preceding items, wherein the composition of the glass consists of, in mass-%:
SiO₂: 20 to 98%, optionally 40 to 75%, optionally 50 to 65%;
B₂O₃: 0 to 30%, optionally 1 to 15%, optionally 3 to 9%;
Al₂O₃: 0 to 30%, optionally 10 to 20%, optionally 13 to 18;
X₂O: 0 to 30%, optionally 0 to 5%, optionally 0 to 3%, wherein X is selected from Na, K, Li, optionally X is Na and/or K;
YO: 0 to 50%, optionally 0.1 to 40%, optionally 10 to 35, wherein Y is selected from Ca, Mg, Ba, optionally Y is Ca and/or Mg;
and unavoidable impurities.

Use of a glassy element provided according to any one of the preceding items in a method comprising a coating process, optionally wherein the coating process comprises a CVD process, optionally a PECVD, PICVD or PACVD process, optionally a PICVD process.

Use of a glassy element provided according to any of the preceding items as a container, optionally a pharmaceutical glass container.

Use of a glassy element provided according to any of the preceding items as a substrate for further processing, optionally structuring.

A method for providing a glassy element comprising the steps:
providing a glassy element comprising a glass mesh structure and gap fillers at least at an interface area;
heating the glassy element to a temperature T, whereas the gap fillers are mobilized in relation to the glass network structure;
exposing at least an interface area of the glassy element to kinetic interaction members having a kinetic energy, whereby the kinetic interaction members interact with the gap fillers, whereby gap fillers are removed from glass mesh structure,
wherein the kinetic interaction members are selected from the group of noble gases or noble gas ions, including any combinations thereof,
wherein the kinetic interaction members are a plasma or are resulting from a plasma and are directed to the interface of the glassy element as effect of having a velocity with a vector pointing towards the respective interface area of the glassy element.

The invention has, against the cited literature, the advantage that the gap fillers are selectively removed from the glass structure network without chemically destroying or altering the glass network structure. Therefore, main glass characteristics are preserved and certain characteristics are modified or improved. This qualifies the inventive glass element as substrate for further processing, such as basis for coatings and coating systems. The coating or coating system can benefit from the modified glass interface in a synergistic manner, for example, it was observed that the adherence of the coating or coating system can be improved when compared to an unmodified glassy element interface.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCE LIST

1 glass network
2 gap filler, e.g. Na⁺
10 glassy element
11 glass network component, e.g. Si
12 glass network component, e.g. O²⁻
4 bulk of glassy element
5 gradient area
50 interface
D width of gradient area
200 reaction chamber
210 vacuum pump
230 microwave or radiowave generator

What is claimed is:

1. A method for providing a glassy element comprising:
providing a glassy element comprising a glass mesh structure and gap fillers at least at an interface area;
heating the glassy element to a temperature T whereas the gap fillers are mobilized in relation to the glass mesh structure;
employing a radio-frequency plasma process that utilizes a plasma; and
exposing the interface area of the glassy element to kinetic interaction members having a kinetic energy, whereby the kinetic interaction members interact with the gap fillers, whereby gap fillers are removed from the glass mesh structure, wherein the kinetic interaction members are selected from the group consisting of noble gas ions, including any combinations thereof, wherein the kinetic interaction members are the plasma or are resulting from the plasma and are directed to the interface area of the glassy element as effect of having a velocity with a vector pointing towards the respective interface area of the glassy element.

2. The method of claim 1, wherein the glass mesh structure at the interface area of the glassy element being exposed to the kinetic interaction members remains unchanged when compared to the glass mesh structure within the volume of the glass element.

3. The method of claim 1, wherein the kinetic interaction members are selected from the group consisting of Ar ions, He ions, Ne ions, Kr ions, Xe ions, and combinations thereof.

4. The method of claim 1, wherein the gap fillers are alkaline metals and/or earth alkaline metals.

5. The method of claim 4, wherein the gap fillers are selected from the group consisting of Li, Na, K, Cs, Mg, Ca, Sr, Ba, respective oxides thereof, and combinations thereof.

6. The method of claim 1, wherein the kinetic interaction members are present in the form of and/or are contained in a process gas, which does not a contain a chemically reactive species for the interface area of the glassy element.

7. The method of claim 1, whereas the removal of gap fillers results in a gradient area within the glassy element in which the concentration of the gap fillers is reduced when compared to an area outside the gradient area which extends from the interface area of the glassy element into its depth and the gradient area has a thickness from 1 nm to 200 nm.

8. The method of claim 1, wherein the heating of the glassy element is achieved by exposing the glassy element to a heating device or by exposing the glassy element to heating gas and/or a heating gas plasma.

9. The method of claim 7, wherein the exposing of the glassy element with the heating gas and/or heating gas plasma results in a pretreatment of the interface area of the glass element.

10. The method of claim 1, wherein during the exposing of the glassy element with the kinetic interaction members no heating gas is present in a surrounding atmosphere.

11. The method of claim 1, wherein the glassy element is heated by exposition with a heating gas or a heating gas plasma, then the heating gas or heating gas plasma is removed from a surrounding atmosphere, then the surrounding atmosphere is introduced to comprise or consist of the kinetic interaction members, then energy is transferred to the kinetic interaction members to expose the glassy element with kinetic interaction members, wherein providing the kinetic interaction members with energy is achieved by the ignition of a plasma of a gas comprising or consisting of the kinetic interaction members by a pulsed plasma process.

12. The method of claim 1, wherein the heating of the glassy element with a heating gas is performed before exposing the glassy element with kinetic interaction members by:
i. surrounding at least part of the interface area of the glassy element with a precursor of the heating gas; and
ii. irradiating a precursor of the heating gas to generate a heating gas plasma;
iii. removing the heating gas and/or the heating gas plasma from an atmosphere after or when a desired temperature of the glassy element is achieved;
iv. surrounding the at least part of the interface area of the glassy element with a precursor of the kinetic reaction members; and
v. irradiating the precursor of the kinetic interaction members to generate a plasma.

13. The method of claim 1, wherein the gap fillers are selected from the group consisting of Na and K, characterized by one or more of the following properties:
the gap filler is Na, wherein a concentration of Na at the interface area is depleted by a factor of at least 5.0, and a factor of 20.0 or less, when compared to a bulk of the glassy element; and
the gap filler is K, wherein a concentration of K at the interface area is enriched by a factor of at least 1.5 when compared to the bulk of the glassy element.

14. The method of claim 1, wherein the plasma collides with the interface area so that a removal of the gap fillers from a surface of the glassy element is achieved by a predominantly physical effect and no chemical reaction of the glass mesh structure takes place.

15. The method of claim 1, wherein the plasma process is a pulsed plasma process in sequences of pulse time and pause time.

16. The method of claim 15, wherein the pause time is greater than the pulse time.

17. A glass element comprising:
a surface;
a bulk,
a glass network structure comprising Si; and
one or more gap fillers selected from the group consisting of Na and K and characterized by one or more of the following properties:
the gap filler is Na, wherein a concentration of Na at the surface is depleted by a factor of at least 5.0 and a factor of 20.0 or less when compared to the bulk; or
the gap filler is K, wherein a concentration of K at the surface is enriched by a factor of at least 1.5 when compared to the bulk.

18. The glass element of claim 17, wherein the surface extends towards the bulk, wherein the surface has a depth of 200 nm or less.

19. A glass element, comprising:
a surface;
a bulk, wherein the surface extends towards the bulk;
a glass network structure comprising Si; and
one or more gap fillers selected from the group consisting of Na and K, wherein one or more of the following conditions is fulfilled:
Na is depleted at the surface, wherein the Na depletion at the surface has a depth of 3 nm or more; or
K is depleted in the surface, wherein the K depletion into the surface has a depth of 2 nm or more.
